(19) United States
(12) Patent Application Publication
(10) Pub. No.: US 2025/0191145 A1
(43) Pub. Date: Jun. 12, 2025

(54) Stacked Image Processing to Reduce Blur for Autonomous Driving

(71) Applicant: Waymo LLC, Mountain View, CA (US)

(72) Inventors: Xiao Geng, Saratoga, CA (US); Xiaoying He, Palo Alto, CA (US); Manfred Ernst, Sunnyvale, CA (US); Matthew Thomas Daniel Rinehart, Mountain View, CA (US); Joseph Patrick Warga, San Francisco, CA (US)

(21) Appl. No.: 18/531,643

(22) Filed: Dec. 6, 2023

(51) Int. Cl. G06T 5/73; G06T 5/50; G06T 5/70; G06T 7/11; G06T 7/20; G06V 10/764

(52) U.S. Cl. CPC G06T 5/73; G06T 5/50; G06T 5/70; G06T 7/11; G06T 7/20; G06V 10/764; G06T 2207/20221

(57) ABSTRACT

A method may include obtaining a plurality of images. Each respective image of the plurality of images may include a corresponding representation of a scene captured by a camera on a vehicle. The method may also include determining, for each respective image of the plurality of images, a corresponding sharpness metric indicative of a sharpness with which the respective image represents the scene. The method may additionally include determining, for each respective image of the plurality of images, a corresponding weight based on the corresponding sharpness metric of the respective image. The method may further include determining an output image by combining the plurality of images according to the corresponding weight of each respective image.

### BACKGROUND

Motion of a camera while capturing an image of a scene may cause the image to include a blurred representation of the scene. This blurred representation may make it difficult to accurately perform various tasks based on the image. For example, blurring of the image may make it difficult to accurately detect visual features within the image.

### SUMMARY

An image burst may include a plurality of images of a scene that are captured in short succession. The images of the plurality of images may vary in sharpness, noise levels, and/or other visual properties. The visual information of the plurality of images may be combined to generate an output image that, in at least some regions, is sharper than any one image of the plurality of images. Specifically, the sharpness of each respective image of the plurality of images may be measured and used to determine one or more weights for the respective image, different regions thereof, and/or different pixels thereof. The output image may be determined by combining the plurality of images according to the weights determined therefor, thus using the visual redundancy of the burst to enhance the representation of the scene in the output image.

In a first example embodiment, a method is provided that includes obtaining a plurality of images. Each respective image of the plurality of images may include a corresponding representation of a scene captured by a camera on a vehicle. The method also includes determining, for each respective image of the plurality of images, a corresponding sharpness metric indicative of a sharpness with which the respective image represents the scene. The method additionally includes determining, for each respective image of the plurality of images, a corresponding weight based on the corresponding sharpness metric of the respective image. The method further includes determining an output image by combining the plurality of images according to the corresponding weight of each respective image.

In a second example embodiment, a system may include a processor and a non-transitory computer-readable medium having stored thereon instructions that, when executed by the processor, cause the processor to perform operations in accordance with the first example embodiment.

In a third example embodiment, a non-transitory computer-readable medium may have stored thereon instructions that, when executed by a computing device, cause the computing device to perform operations in accordance with the first example embodiment.

In a fourth example embodiment, a system may include various means for carrying out each of the operations of the first example embodiment.

In a fifth example embodiment, a system may include circuitry (e.g., processor, hardware accelerator, integrated circuit, and/or system on chip, etc.) configured to perform operations in accordance with the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a functional block diagram illustrating a vehicle, in accordance with examples described herein.

FIG. 2A is an illustration of a physical configuration of a vehicle, in accordance with examples described herein.

FIG. 2B is an illustration of a physical configuration of a vehicle, in accordance with examples described herein.

FIG. 2C is an illustration of a physical configuration of a vehicle, in accordance with examples described herein.

FIG. 2D is an illustration of a physical configuration of a vehicle, in accordance with examples described herein.

FIG. 2E is an illustration of a physical configuration of a vehicle, in accordance with examples described herein.

FIG. 3 is a conceptual illustration of wireless communication between various computing systems related to an autonomous or semi-autonomous vehicle, in accordance with examples described herein.

FIG. 4 illustrates an image processing system, in accordance with examples described herein.

FIG. 5A illustrates an input image, in accordance with examples described herein.

FIG. 5B illustrates a segmentation mask, in accordance with examples described herein.

FIG. 5C illustrates an importance mask, in accordance with examples described herein.

FIG. 5D illustrates an output image, in accordance with examples described herein.

FIG. 6 is a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

An image captured by a camera may include blurring caused by motion of the camera relative to a scene and/or motion of portions of the scene relative to the camera. For example, images captured by a camera on a vehicle may include blurring due to motion of the vehicle relative to the scene and/or portions thereof. Blurring may be undesirable in some applications, as it may make various image processing tasks more difficult to perform and/or the results thereof less accurate. Thus, it is desirable to reduce the amount of blurring present in an image (i.e., increase the sharpness of the image).

An image processing system may be configured to improve the sharpness with which an image represents a scene by combining visual information of a plurality of images that represent the scene. The plurality of images may be captured sequentially within a predetermined period of time, and may thus represent the scene with relatively minor differences in perspective. The image processing system may be configured to determine, for each respective image of the plurality of images, a corresponding sharpness metric. The corresponding sharpness metric may be based on a gradient of the respective image, an exposure time used in connection with generating the respective image, an optical flow between the respective image and one or more other images of the plurality of images, an output of processing the respective image by a machine learning model, and/or motion data generated by, for example, an inertial measurement unit associated with the camera and/or a speedometer of the vehicle, among other possibilities.

The image processing system may also be configured to determine, for each respective image of the plurality of images, a corresponding weight based on the corresponding sharpness metric. The image processing system may be configured to generate an output image having an improved sharpness by aligning the plurality of images and combining the plurality of images according to the corresponding weights thereof.

The corresponding weight may indicate a relative contribution of the respective image to the output image. The corresponding weight may be proportional to the corresponding sharpness metric, thus allowing sharper image content to be amplified and blurred content to be attenuated when combining the plurality of images. The corresponding weights and/or the resulting pixel values of the output image may be normalized to maintain pixel values of the output image within a predetermined range (e.g., the corresponding weights for the plurality of images may sum to 1).

In some implementations, the corresponding weight of the respective image may include a frame weight applicable to the image as a whole (e.g., based on a sharpness metric for the whole image), region weights applicable to different pixel groups (e.g., semantically-distinct regions) within the respective image (e.g., based on sharpness metrics for individual pixel groups), and/or pixel weights applicable to different pixels within the respective image (e.g., based on sharpness metrics for individual pixels). Thus, the relative contribution of a given pixel within the respective image may be based on a product of the frame weight of the respective image, the region weight for a pixel group within which the given pixel is found, and/or a pixel weight corresponding to the given pixel. By using the frame weights, region weights, and/or pixel weights, the image processing system may account for spatial variations in the degree of sharpness present across different portions of each of the plurality of images.

The corresponding weight may additionally and/or alternatively be based on a time at which the respective image has been captured, a signal-to-noise ratio (SNR) associated with the respective image, and/or other properties of the respective image. For example, a more recently captured image may be assigned a higher weight than a less recently captured image. As another example, an image with a higher SNR may be assigned a higher weight than an image with a lower SNR. Different sub-weights resulting from consideration of different aspects of the respective image (e.g., a sharpness-based sub-weight, a time-based sub-weight, a SNR-based sub-weight, etc.) may be combined into a total weight for the image by adding, multiplying, and/or otherwise combining the sub-weights.

In some implementations, the image processing system may also utilize a segmentation mask to further improve the process of generating the output image. The segmentation mask may be generated, for example, by processing one or more of the plurality of images using a machine learning model that has been trained to segment images into a plurality of visual feature classes. Depending on the task for which the plurality of images are to be used, some visual feature classes may be more important than others in performance of the task. For example, in the context of an autonomous vehicle, road regions and sidewalk regions may be more important than sky regions.

Accordingly, the image processing system may be configured to, for a given image of the plurality of images, denoise (e.g., by blurring or other techniques) some pixels of the given image based on a visual feature class represented by these pixels. For example, an extent of denoising applied to pixels representing an object of a given visual feature class may be based on an importance of the given visual feature class to a task for which the images are to be used. Denoising might not be applied to some visual feature classes (e.g., visual feature classes that are important to the task) to preserve high-frequency details of these classes. Denoising a region of pixels may allow the region of pixels to be compressed to a greater extent, thus allowing for higher compression ratios and reducing an amount of data used to represent the images.

The following description and accompanying drawings will elucidate features of various example embodiments. The embodiments provided are by way of example, and are not intended to be limiting. As such, the dimensions of the drawings are not necessarily to scale.

Example systems within the scope of the present disclosure will now be described in greater detail. An example system may be implemented in or may take the form of an automobile. Additionally, an example system may also be implemented in or take the form of various vehicles, such as cars, trucks (e.g., pickup trucks, vans, tractors, and tractor trailers), motorcycles, buses, airplanes, helicopters, drones, lawn mowers, earth movers, boats, submarines, all-terrain vehicles, snowmobiles, aircraft, recreational vehicles, amusement park vehicles, farm equipment or vehicles, construction equipment or vehicles, warehouse equipment or vehicles, factory equipment or vehicles, trams, golf carts, trains, trolleys, sidewalk delivery vehicles, and robot devices. Other vehicles are possible as well. Further, in some embodiments, example systems might not include a vehicle.

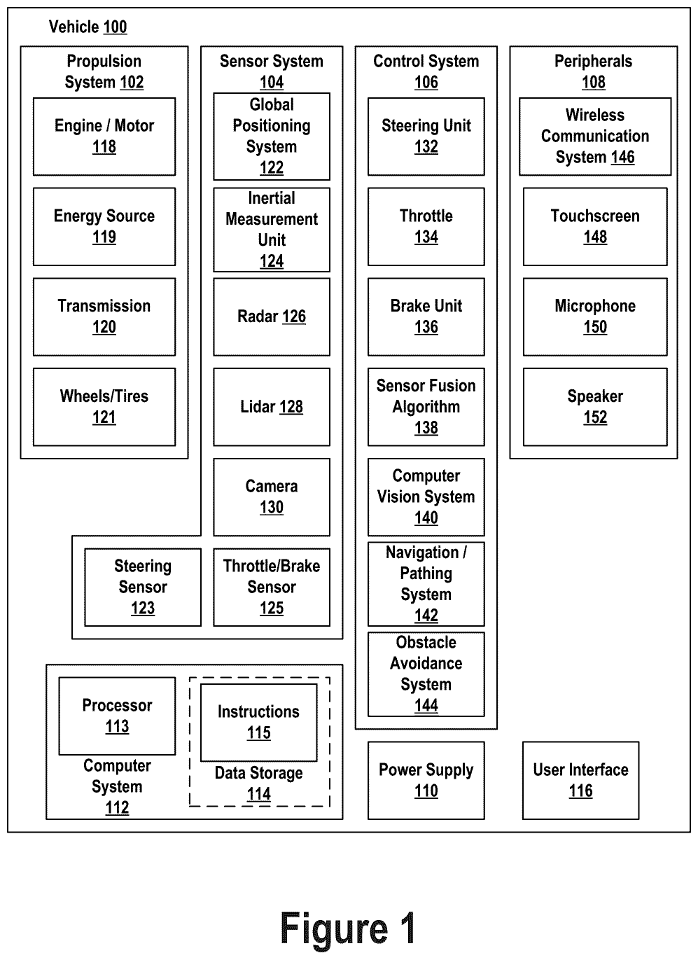

Referring now to the figures, FIG. 1 is a functional block diagram illustrating example vehicle 100, which may be configured to operate fully or partially in an autonomous mode. More specifically, vehicle 100 may operate in an autonomous mode without human interaction through receiving control instructions from a computing system. As part of operating in the autonomous mode, vehicle 100 may use sensors to detect and possibly identify objects of the surrounding environment to enable safe navigation. Additionally, example vehicle 100 may operate in a partially autonomous (i.e., semi-autonomous) mode in which some functions of the vehicle 100 are controlled by a human driver of the vehicle 100 and some functions of the vehicle 100 are controlled by the computing system. For example, vehicle 100 may also include subsystems that enable the driver to control operations of vehicle 100 such as steering, acceleration, and braking, while the computing system performs assistive functions such as lane-departure warnings/lane-keeping assist or adaptive cruise control based on other objects (e.g., vehicles) in the surrounding environment.

As described herein, in a partially autonomous driving mode, even though the vehicle assists with one or more driving operations (e.g., steering, braking and/or accelerating to perform lane centering, adaptive cruise control, advanced driver assistance systems (ADAS), and emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods are described below in conjunction with autonomous vehicles, these or similar systems and methods can be used in various driver assistance systems that do not rise to the level of fully autonomous driving systems (i.e. partially autonomous driving systems). In the United States, the Society of Automotive Engineers (SAE) have defined different levels of automated driving operations to indicate how much, or how little, a vehicle controls the driving, although different organizations, in the United States or in other countries, may categorize the levels differently. More specifically, the disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway) conditions. Likewise, the disclosed systems and methods can be used in vehicles that use SAE Level 4 self-driving systems that operate autonomously under most regular driving situations and require only occasional attention of the human operator. In all such systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

As shown in FIG. 1, vehicle 100 may include various subsystems, such as propulsion system 102, sensor system 104, control system 106, one or more peripherals 108, power supply 110, computer system 112 (which could also be referred to as a computing system) with data storage 114, and user interface 116. In other examples, vehicle 100 may include more or fewer subsystems, which can each include multiple elements. The subsystems and components of vehicle 100 may be interconnected in various ways. In addition, functions of vehicle 100 described herein can be divided into additional functional or physical components, or combined into fewer functional or physical components within embodiments. For instance, the control system 106 and the computer system 112 may be combined into a single system that operates the vehicle 100 in accordance with various operations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, an electric motor, steam engine, or Stirling engine, among other possible options. For instance, in some embodiments, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118). For instance, energy source 119 can correspond to gasoline, diesel, other petroleum-based fuels, propane, other compressed gas-based fuels, ethanol, solar panels, batteries, and/or other sources of electrical power. In some embodiments, energy source 119 may include a combination of fuel tanks, batteries, capacitors, and/or flywheels.

Transmission 120 may transmit mechanical power from engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example embodiments. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, radar 126, lidar 128, camera 130, steering sensor 123, and throttle/brake sensor 125, among other possible sensors. In some embodiments, sensor system 104 may also include sensors configured to monitor internal systems of the vehicle 100 (e.g., O₂ monitor, fuel gauge, engine oil temperature, and brake wear).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar 126 may represent one or more systems configured to use radio signals to sense objects, including the speed and heading of the objects, within the surrounding environment of vehicle 100. As such, radar 126 may include antennas configured to transmit and receive radio signals. In some embodiments, radar 126 may correspond to a mountable radar configured to obtain measurements of the surrounding environment of vehicle 100.

Lidar 128 may include one or more laser sources, a laser scanner, and one or more detectors, among other system components, and may operate in a coherent mode (e.g., using heterodyne detection) or in an incoherent detection mode (i.e., time-of-flight mode). In some embodiments, the one or more detectors of the lidar 128 may include one or more photodetectors, which may be especially sensitive detectors (e.g., avalanche photodiodes). In some examples, such photodetectors may be capable of detecting single photons (e.g., single-photon avalanche diodes (SPADs)). Further, such photodetectors can be arranged (e.g., through an electrical connection in series) into an array (e.g., as in a silicon photomultiplier (SiPM)). In some examples, the one or more photodetectors are Geiger-mode operated devices and the lidar includes subcomponents designed for such Geiger-mode operation.

Camera 130 may include one or more devices (e.g., still camera, video camera, a thermal imaging camera, a stereo camera, and a night vision camera) configured to capture images of the surrounding environment of vehicle 100.

Steering sensor 123 may sense a steering angle of vehicle 100, which may involve measuring an angle of the steering wheel or measuring an electrical signal representative of the angle of the steering wheel. In some embodiments, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, an angle of a gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve and a carburetor). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other embodiments, throttle/brake sensor 125 may be configured to measure a pressure applied to a pedal of the vehicle, such as a throttle or brake pedal.

Control system 106 may include components configured to assist in navigating vehicle 100, such as steering unit 132, throttle 134, brake unit 136, sensor fusion algorithm 138, computer vision system 140, navigation/pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some embodiments, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some embodiments, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software (e.g., a general purpose processor such as a central processing unit (CPU), a specialized processor such as a graphical processing unit (GPU) or a tensor processing unit (TPU), an application-specific integrated circuit (ASIC), a field programmable gate array (FPGA), a volatile memory, a non-volatile memory, or one or more machine-learned models) operable to process and analyze images in an effort to determine objects that are in motion (e.g., other vehicles, pedestrians, bicyclists, or animals) and objects that are not in motion (e.g., traffic lights, roadway boundaries, speedbumps, or potholes). As such, computer vision system 140 may use object recognition, Structure From Motion (SFM), video tracking, and other algorithms used in computer vision, for instance, to recognize objects, map an environment, track objects, estimate the speed of objects, etc.

Navigation/pathing system 142 may determine a driving path for vehicle 100, which may involve dynamically adjusting navigation during operation. As such, navigation/pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, interior microphone 150, and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may wirelessly communicate with one or more devices directly or via a communication network. For example, wireless communication system 146 could use 3G cellular communication, such as code-division multiple access (CDMA), evolution-data optimized (EVDO), global system for mobile communications (GSM)/general packet radio service (GPRS), or cellular communication, such as 4G worldwide interoperability for microwave access (WiMAX) or long-term evolution (LTE), or 5G. Alternatively, wireless communication system 146 may communicate with a wireless local area network (WLAN) using WIFI® or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some embodiments. For instance, power supply 110 may include one or more batteries configured to provide electrical power. Vehicle 100 may also use other types of power supplies. In an example embodiment, power supply 110 and energy source 119 may be integrated into a single energy source.

Vehicle 100 may also include computer system 112 to perform operations, such as operations described therein. As such, computer system 112 may include at least one processor 113 (which could include at least one microprocessor) operable to execute instructions 115 stored in a non-transitory, computer-readable medium, such as data storage 114. In some embodiments, computer system 112 may represent a plurality of computing devices that may serve to control individual components or subsystems of vehicle 100 in a distributed fashion.

In some embodiments, data storage 114 may contain instructions 115 (e.g., program logic) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, or control system 106), as well as from user interface 116. For example, computer system 112 may utilize input from sensor system 104 in order to estimate the output produced by propulsion system 102 and control system 106. Depending upon the embodiment, computer system 112 could be operable to monitor many aspects of vehicle 100 and its subsystems. In some embodiments, computer system 112 may disable some or all functions of the vehicle 100 based on signals received from sensor system 104.

The components of vehicle 100 could be configured to work in an interconnected fashion with other components within or outside their respective systems. For instance, in an example embodiment, camera 130 could capture a plurality of images that could represent information about a state of a surrounding environment of vehicle 100 operating in an autonomous or semi-autonomous mode. The state of the surrounding environment could include parameters of the road on which the vehicle is operating. For example, computer vision system 140 may be able to recognize the slope (grade) or other features based on the plurality of images of a roadway. Additionally, the combination of GPS 122 and the features recognized by computer vision system 140 may be used with map data stored in data storage 114 to determine specific road parameters. Further, radar 126 and/or lidar 128, and/or some other environmental mapping, ranging, and/or positioning sensor system may also provide information about the surroundings of the vehicle.

In other words, a combination of various sensors (which could be termed input-indication and output-indication sensors) and computer system 112 could interact to provide an indication of an input provided to control a vehicle or an indication of the surroundings of a vehicle.

In some embodiments, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors.

Although FIG. 1 shows various components of vehicle 100 (i.e., wireless communication system 146, computer system 112, data storage 114, and user interface 116) as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

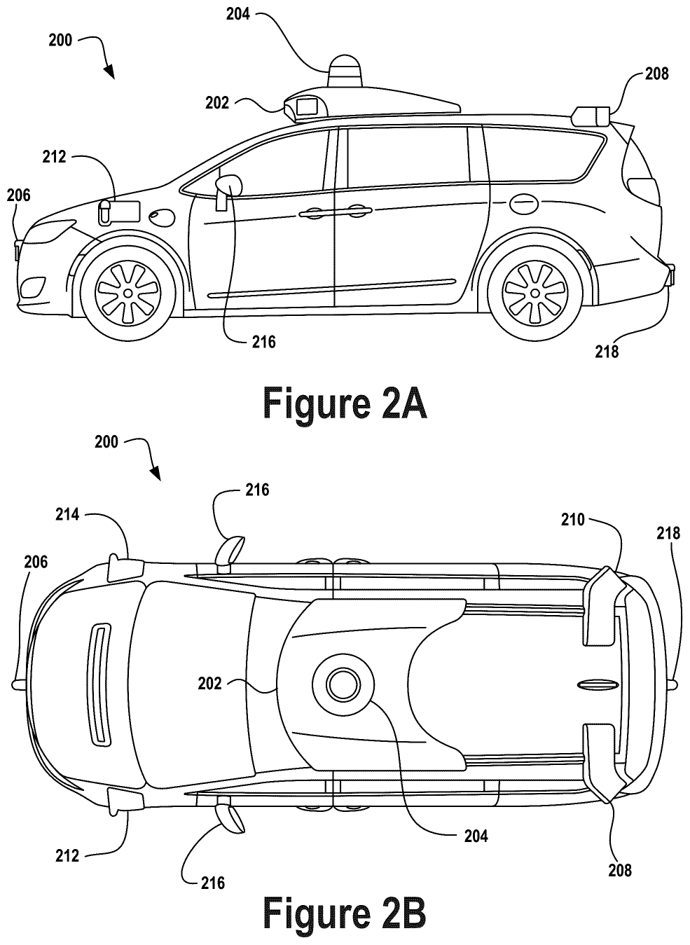

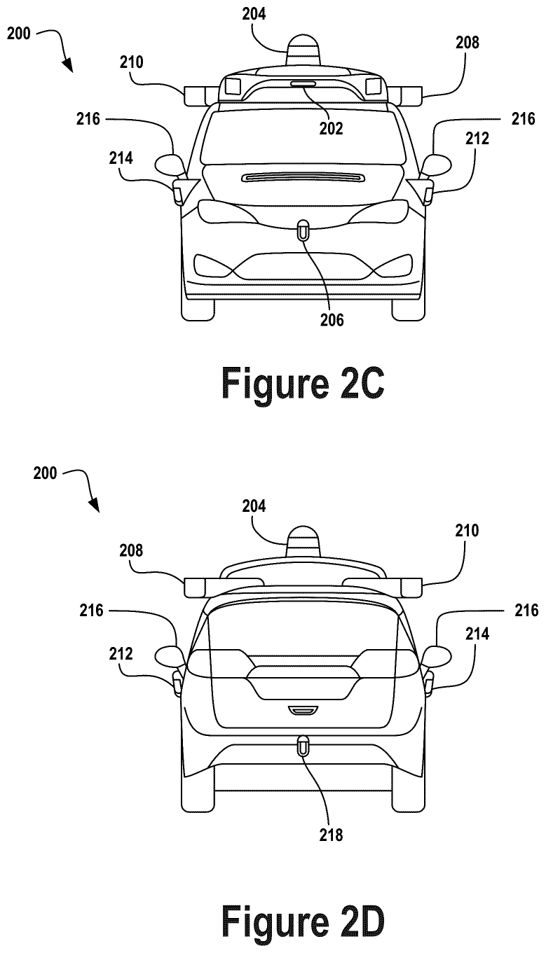

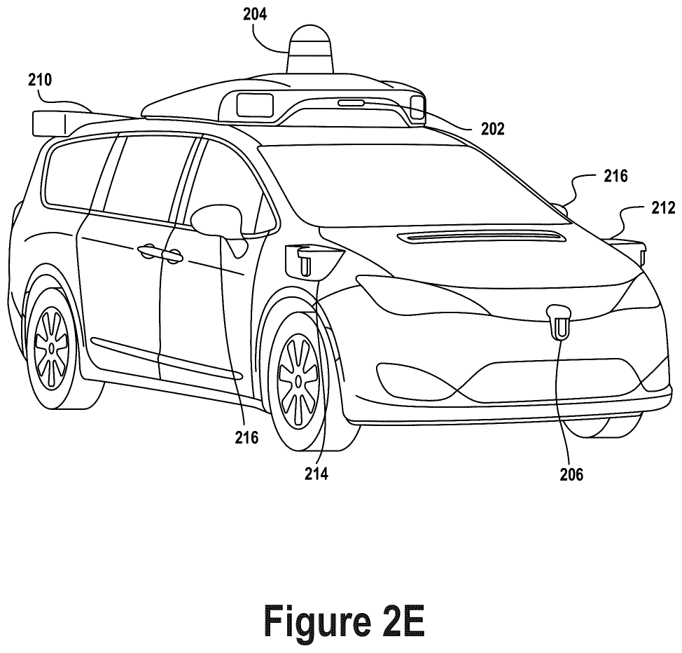

FIGS. 2A-2E show an example vehicle 200 (e.g., a fully autonomous vehicle or semi-autonomous vehicle) that can include some or all of the functions described in connection with vehicle 100 in reference to FIG. 1. Although vehicle 200 is illustrated in FIGS. 2A-2E as a van with side view mirrors for illustrative purposes, the present disclosure is not so limited. For instance, the vehicle 200 can represent a truck, a car, a semi-trailer truck, a motorcycle, a golf cart, an off-road vehicle, a farm vehicle, or any other vehicle that is described elsewhere herein (e.g., buses, boats, airplanes, helicopters, drones, lawn mowers, earth movers, submarines, all-terrain vehicles, snowmobiles, aircraft, recreational vehicles, amusement park vehicles, farm equipment, construction equipment or vehicles, warehouse equipment or vehicles, factory equipment or vehicles, trams, trains, trolleys, sidewalk delivery vehicles, and robot devices).

The example vehicle 200 may include one or more sensor systems 202, 204, 206, 208, 210, 212, 214, and 218. In some embodiments, sensor systems 202, 204, 206, 208, 210, 212, 214, and/or 218 could represent one or more optical systems (e.g. cameras), one or more lidars, one or more radars, one or more inertial sensors, one or more humidity sensors, one or more acoustic sensors (e.g., microphones and sonar devices), or one or more other sensors configured to sense information about an environment surrounding the vehicle 200. In other words, any sensor system now known or later created could be coupled to the vehicle 200 and/or could be utilized in conjunction with various operations of the vehicle 200. As an example, a lidar could be utilized in self-driving or other types of navigation, planning, perception, and/or mapping operations of the vehicle 200. In addition, sensor systems 202, 204, 206, 208, 210, 212, 214, and/or 218 could represent a combination of sensors described herein (e.g., one or more lidars and radars; one or more lidars and cameras; one or more cameras and radars; or one or more lidars, cameras, and radars).

Note that the number, location, and type of sensor systems (e.g., 202 and 204) depicted in FIGS. 2A-E are intended as a non-limiting example of the location, number, and type of such sensor systems of an autonomous or semi-autonomous vehicle. Alternative numbers, locations, types, and configurations of such sensors are possible (e.g., to comport with vehicle size, shape, aerodynamics, fuel economy, aesthetics, or other conditions, to reduce cost, or to adapt to specialized environmental or application circumstances). For example, the sensor systems (e.g., 202 and 204) could be disposed in various other locations on the vehicle (e.g., at location 216) and could have fields of view that correspond to internal and/or surrounding environments of the vehicle 200.

The sensor system 202 may be mounted atop the vehicle 200 and may include one or more sensors configured to detect information about an environment surrounding the vehicle 200, and output indications of the information. For example, sensor system 202 can include any combination of cameras, radars, lidars, inertial sensors, humidity sensors, and acoustic sensors (e.g., microphones and sonar devices). The sensor system 202 can include one or more movable mounts that could be operable to adjust the orientation of one or more sensors in the sensor system 202. In one embodiment, the movable mount could include a rotating platform that could scan sensors so as to obtain information from each direction around the vehicle 200. In another embodiment, the movable mount of the sensor system 202 could be movable in a scanning fashion within a particular range of angles and/or azimuths and/or elevations. The sensor system 202 could be mounted atop the roof of a car, although other mounting locations are possible.

Additionally, the sensors of sensor system 202 could be distributed in different locations and need not be collocated in a single location. Furthermore, each sensor of sensor system 202 can be configured to be moved or scanned independently of other sensors of sensor system 202. Additionally or alternatively, multiple sensors may be mounted at one or more of the sensor locations 202, 204, 206, 208, 210, 212, 214, and/or 218. For example, there may be two lidar devices mounted at a sensor location and/or there may be one lidar device and one radar mounted at a sensor location.

The one or more sensor systems 202, 204, 206, 208, 210, 212, 214, and/or 218 could include one or more lidar devices. For example, the lidar devices could include a plurality of light-emitter devices arranged over a range of angles with respect to a given plane (e.g., the x-y plane). For example, one or more of the sensor systems 202, 204, 206, 208, 210, 212, 214, and/or 218 may be configured to rotate or pivot about an axis (e.g., the z-axis) perpendicular to the given plane so as to illuminate an environment surrounding the vehicle 200 with light pulses. Based on detecting various aspects of reflected light pulses (e.g., the elapsed time of flight, polarization, and intensity), information about the surrounding environment may be determined.

In an example embodiment, sensor systems 202, 204, 206, 208, 210, 212, 214, and/or 218 may be configured to provide respective point cloud information that may relate to physical objects within the surrounding environment of the vehicle 200. While vehicle 200 and sensor systems 202, 204, 206, 208, 210, 212, 214, and 218 are illustrated as including certain features, it will be understood that other types of sensor systems are contemplated within the scope of the present disclosure. Further, the example vehicle 200 can include any of the components described in connection with vehicle 100 of FIG. 1.

In an example configuration, one or more radars can be located on vehicle 200. Similar to radar 126 described above, the one or more radars may include antennas configured to transmit and receive radio waves (e.g., electromagnetic waves having frequencies between 30 Hz and 300 GHz). Such radio waves may be used to determine the distance to and/or velocity of one or more objects in the surrounding environment of the vehicle 200. For example, one or more sensor systems 202, 204, 206, 208, 210, 212, 214, and/or 218 could include one or more radars. In some examples, one or more radars can be located near the rear of the vehicle 200 (e.g., sensor systems 208 and 210), to actively scan the environment near the back of the vehicle 200 for the presence of radio-reflective objects. Similarly, one or more radars can be located near the front of the vehicle 200 (e.g., sensor systems 212 or 214) to actively scan the environment near the front of the vehicle 200. A radar can be situated, for example, in a location suitable to illuminate a region including a forward-moving path of the vehicle 200 without occlusion by other features of the vehicle 200. For example, a radar can be embedded in and/or mounted in or near the front bumper, front headlights, cowl, and/or hood, etc. Furthermore, one or more additional radars can be located to actively scan the side and/or rear of the vehicle 200 for the presence of radio-reflective objects, such as by including such devices in or near the rear bumper, side panels, rocker panels, and/or undercarriage, etc.

The vehicle 200 can include one or more cameras. For example, the one or more sensor systems 202, 204, 206, 208, 210, 212, 214, and/or 218 could include one or more cameras. The camera can be a photosensitive instrument, such as a still camera, a video camera, a thermal imaging camera, a stereo camera, a night vision camera, etc., that is configured to capture a plurality of images of the surrounding environment of the vehicle 200. To this end, the camera can be configured to detect visible light, and can additionally or alternatively be configured to detect light from other portions of the spectrum, such as infrared or ultraviolet light. The camera can be a two-dimensional detector, and can optionally have a three-dimensional spatial range of sensitivity. In some embodiments, the camera can include, for example, a range detector configured to generate a two-dimensional image indicating distance from the camera to a number of points in the surrounding environment. To this end, the camera may use one or more range detecting techniques. For example, the camera can provide range information by using a structured light technique in which the vehicle 200 illuminates an object in the surrounding environment with a predetermined light pattern, such as a grid or checkerboard pattern and uses the camera to detect a reflection of the predetermined light pattern from environmental surroundings. Based on distortions in the reflected light pattern, the vehicle 200 can determine the distance to the points on the object. The predetermined light pattern may comprise infrared light, or radiation at other suitable wavelengths for such measurements. In some examples, the camera can be mounted inside a front windshield of the vehicle 200. Specifically, the camera can be situated to capture images from a forward-looking view with respect to the orientation of the vehicle 200. Other mounting locations and viewing angles of the camera can also be used, either inside or outside the vehicle 200. Further, the camera can have associated optics operable to provide an adjustable field of view. Still further, the camera can be mounted to vehicle 200 with a movable mount to vary a pointing angle of the camera, such as via a pan/tilt mechanism.

The vehicle 200 may also include one or more acoustic sensors (e.g., one or more of the sensor systems 202, 204, 206, 208, 210, 212, 214, 216, 218 may include one or more acoustic sensors) used to sense a surrounding environment of vehicle 200. Acoustic sensors may include microphones (e.g., piezoelectric microphones, condenser microphones, ribbon microphones, or microelectromechanical systems (MEMS) microphones) used to sense acoustic waves (i.e., pressure differentials) in a fluid (e.g., air) of the environment surrounding the vehicle 200. Such acoustic sensors may be used to identify sounds in the surrounding environment (e.g., sirens, human speech, animal sounds, or alarms) upon which control strategy for vehicle 200 may be based. For example, if the acoustic sensor detects a siren (e.g., an ambulatory siren or a fire engine siren), vehicle 200 may slow down and/or navigate to the edge of a roadway.

Although not shown in FIGS. 2A-2E, the vehicle 200 can include a wireless communication system (e.g., similar to the wireless communication system 146 of FIG. 1 and/or in addition to the wireless communication system 146 of FIG. 1). The wireless communication system may include wireless transmitters and receivers that could be configured to communicate with devices external or internal to the vehicle 200. Specifically, the wireless communication system could include transceivers configured to communicate with other vehicles and/or computing devices, for instance, in a vehicular communication system or a roadway station. Examples of such vehicular communication systems include DSRC, radio frequency identification (RFID), and other proposed communication standards directed towards intelligent transport systems.

The vehicle 200 may include one or more other components in addition to or instead of those shown. The additional components may include electrical or mechanical functionality.

A control system of the vehicle 200 may be configured to control the vehicle 200 in accordance with a control strategy from among multiple possible control strategies. The control system may be configured to receive information from sensors coupled to the vehicle 200 (on or off the vehicle 200), modify the control strategy (and an associated driving behavior) based on the information, and control the vehicle 200 in accordance with the modified control strategy. The control system further may be configured to monitor the information received from the sensors, and continuously evaluate driving conditions; and also may be configured to modify the control strategy and driving behavior based on changes in the driving conditions. For example, a route taken by a vehicle from one destination to another may be modified based on driving conditions. Additionally or alternatively, the velocity, acceleration, turn angle, follow distance (i.e., distance to a vehicle ahead of the present vehicle), lane selection, etc. could all be modified in response to changes in the driving conditions.

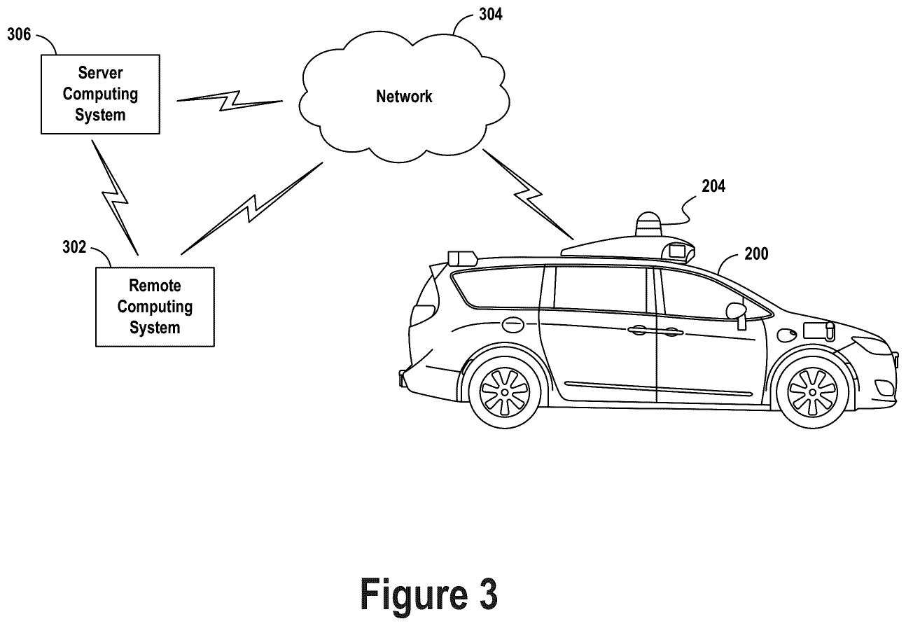

FIG. 3 is a conceptual illustration of wireless communication between various computing systems related to an autonomous or semi-autonomous vehicle, according to example embodiments. In particular, wireless communication may occur between remote computing system 302 and vehicle 200 via network 304. Wireless communication may also occur between server computing system 306 and remote computing system 302, and between server computing system 306 and vehicle 200.

Vehicle 200 can correspond to various types of vehicles capable of transporting passengers or objects between locations, and may take the form of any one or more of the vehicles discussed above. In some instances, vehicle 200 may operate in an autonomous or semi-autonomous mode that enables a control system to safely navigate vehicle 200 between destinations using sensor measurements. When operating in an autonomous or semi-autonomous mode, vehicle 200 may navigate with or without passengers. As a result, vehicle 200 may pick up and drop off passengers between desired destinations.

Remote computing system 302 may represent any type of device related to remote assistance techniques, including but not limited to those described herein. Within examples, remote computing system 302 may represent any type of device configured to (i) receive information related to vehicle 200, (ii) provide an interface through which a human operator can in turn perceive the information and input a response related to the information, and (iii) transmit the response to vehicle 200 or to other devices. Remote computing system 302 may take various forms, such as a workstation, a desktop computer, a laptop, a tablet, a mobile phone (e.g., a smart phone), and/or a server. In some examples, remote computing system 302 may include multiple computing devices operating together in a network configuration.

Remote computing system 302 may include one or more subsystems and components similar or identical to the subsystems and components of vehicle 200. At a minimum, remote computing system 302 may include a processor configured for performing various operations described herein. In some embodiments, remote computing system 302 may also include a user interface that includes input/output devices, such as a touchscreen and a speaker. Other examples are possible as well.

Network 304 represents infrastructure that enables wireless communication between remote computing system 302 and vehicle 200. Network 304 also enables wireless communication between server computing system 306 and remote computing system 302, and between server computing system 306 and vehicle 200.

The position of remote computing system 302 can vary within examples. For instance, remote computing system 302 may have a remote position from vehicle 200 that has a wireless communication via network 304. In another example, remote computing system 302 may correspond to a computing device within vehicle 200 that is separate from vehicle 200, but with which a human operator can interact while a passenger or driver of vehicle 200. In some examples, remote computing system 302 may be a computing device with a touchscreen operable by the passenger of vehicle 200.

In some embodiments, operations described herein that are performed by remote computing system 302 may be additionally or alternatively performed by vehicle 200 (i.e., by any system(s) or subsystem(s) of vehicle 200). In other words, vehicle 200 may be configured to provide a remote assistance mechanism with which a driver or passenger of the vehicle can interact.

Server computing system 306 may be configured to wirelessly communicate with remote computing system 302 and vehicle 200 via network 304 (or perhaps directly with remote computing system 302 and/or vehicle 200). Server computing system 306 may represent any computing device configured to receive, store, determine, and/or send information relating to vehicle 200 and the remote assistance thereof. As such, server computing system 306 may be configured to perform any operation(s), or portions of such operation(s), that is/are described herein as performed by remote computing system 302 and/or vehicle 200. Some embodiments of wireless communication related to remote assistance may utilize server computing system 306, while others may not.

Server computing system 306 may include one or more subsystems and components similar or identical to the subsystems and components of remote computing system 302 and/or vehicle 200, such as a processor configured for performing various operations described herein, and a wireless communication interface for receiving information from, and providing information to, remote computing system 302 and vehicle 200.

The various systems described above may perform various operations. These operations and related features will now be described.

In line with the discussion above, a computing system (e.g., remote computing system 302, server computing system 306, or a computing system local to vehicle 200) may operate to use a camera to capture images of the surrounding environment of an autonomous or semi-autonomous vehicle. In general, at least one computing system will be able to analyze the images and possibly control the autonomous or semi-autonomous vehicle.

In some embodiments, to facilitate autonomous or semi-autonomous operation, a vehicle (e.g., vehicle 200) may receive data representing objects in an environment surrounding the vehicle (also referred to herein as “environment data”) in a variety of ways. A sensor system on the vehicle may provide the environment data representing objects of the surrounding environment. For example, the vehicle may have various sensors, including a camera, a radar, a lidar, a microphone, a radio unit, and other sensors. Each of these sensors may communicate environment data to a processor in the vehicle about information each respective sensor receives.

In one example, a camera may be configured to capture still images and/or video. In some embodiments, the vehicle may have more than one camera positioned in different orientations. Also, in some embodiments, the camera may be able to move to capture images and/or video in different directions. The camera may be configured to store captured images and video to a memory for later processing by a processing system of the vehicle. The captured images and/or video may be the environment data. Further, the camera may include an image sensor as described herein.

In another example, a radar may be configured to transmit an electromagnetic signal that will be reflected by various objects near the vehicle, and then capture electromagnetic signals that reflect off the objects. The captured reflected electromagnetic signals may enable the radar (or processing system) to make various determinations about objects that reflected the electromagnetic signal. For example, the distances to and positions of various reflecting objects may be determined. In some embodiments, the vehicle may have more than one radar in different orientations. The radar may be configured to store captured information to a memory for later processing by a processing system of the vehicle. The information captured by the radar may be environment data.

In another example, a lidar may be configured to transmit an electromagnetic signal (e.g., infrared light, such as that from a gas or diode laser, or other possible light source) that will be reflected by target objects near the vehicle. The lidar may be able to capture the reflected electromagnetic (e.g., infrared light) signals. The captured reflected electromagnetic signals may enable the range-finding system (or processing system) to determine a range to various objects. The lidar may also be able to determine a velocity or speed of target objects and store it as environment data.

Additionally, in an example, a microphone may be configured to capture audio of the environment surrounding the vehicle. Sounds captured by the microphone may include emergency vehicle sirens and the sounds of other vehicles. For example, the microphone may capture the sound of the siren of an ambulance, fire engine, or police vehicle. A processing system may be able to identify that the captured audio signal is indicative of an emergency vehicle. In another example, the microphone may capture the sound of an exhaust of another vehicle, such as that from a motorcycle. A processing system may be able to identify that the captured audio signal is indicative of a motorcycle. The data captured by the microphone may form a portion of the environment data.

In yet another example, the radio unit may be configured to transmit an electromagnetic signal that may take the form of a Bluetooth signal, 802.11 signal, and/or other radio technology signal. The first electromagnetic radiation signal may be transmitted via one or more antennas located in a radio unit. Further, the first electromagnetic radiation signal may be transmitted with one of many different radio-signaling modes. However, in some embodiments it is desirable to transmit the first electromagnetic radiation signal with a signaling mode that requests a response from devices located near the autonomous or semi-autonomous vehicle. The processing system may be able to detect nearby devices based on the responses communicated back to the radio unit and use this communicated information as a portion of the environment data.

In some embodiments, the processing system may be able to combine information from the various sensors in order to make further determinations of the surrounding environment of the vehicle. For example, the processing system may combine data from both radar information and a captured image to determine if another vehicle or pedestrian is in front of the autonomous or semi-autonomous vehicle. In other embodiments, other combinations of sensor data may be used by the processing system to make determinations about the surrounding environment.

While operating in an autonomous mode (or semi-autonomous mode), the vehicle may control its operation with little-to-no human input. For example, a human-operator may enter an address into the vehicle and the vehicle may then be able to drive, without further input from the human (e.g., the human does not have to steer or touch the brake/gas pedals), to the specified destination. Further, while the vehicle is operating autonomously or semi-autonomously, the sensor system may be receiving environment data. The processing system of the vehicle may alter the control of the vehicle based on environment data received from the various sensors. In some examples, the vehicle may alter a velocity of the vehicle in response to environment data from the various sensors. The vehicle may change velocity in order to avoid obstacles, obey traffic laws, etc. When a processing system in the vehicle identifies objects near the vehicle, the vehicle may be able to change velocity, or alter the movement in another way.

When the vehicle detects an object but is not highly confident in the detection of the object, the vehicle can request a human operator (or a more powerful computer) to perform one or more remote assistance tasks, such as (i) confirm whether the object is in fact present in the surrounding environment (e.g., if there is actually a stop sign or if there is actually no stop sign present), (ii) confirm whether the vehicle's identification of the object is correct, (iii) correct the identification if the identification was incorrect, and/or (iv) provide a supplemental instruction (or modify a present instruction) for the autonomous or semi-autonomous vehicle. Remote assistance tasks may also include the human operator providing an instruction to control operation of the vehicle (e.g., instruct the vehicle to stop at a stop sign if the human operator determines that the object is a stop sign), although in some scenarios, the vehicle itself may control its own operation based on the human operator's feedback related to the identification of the object.

To facilitate this, the vehicle may analyze the environment data representing objects of the surrounding environment to determine at least one object having a detection confidence below a threshold. A processor in the vehicle may be configured to detect various objects of the surrounding environment based on environment data from various sensors. For example, in one embodiment, the processor may be configured to detect objects that may be important for the vehicle to recognize. Such objects may include pedestrians, bicyclists, street signs, other vehicles, indicator signals on other vehicles, and other various objects detected in the captured environment data.

The detection confidence may be indicative of a likelihood that the determined object is correctly identified in the surrounding environment, or is present in the surrounding environment. For example, the processor may perform object detection of objects within image data in the received environment data, and determine that at least one object has the detection confidence below the threshold based on being unable to identify the object with a detection confidence above the threshold. If a result of an object detection or object recognition of the object is inconclusive, then the detection confidence may be low or below the set threshold.

The vehicle may detect objects of the surrounding environment in various ways depending on the source of the environment data. In some embodiments, the environment data may come from a camera and be image or video data. In other embodiments, the environment data may come from a lidar. The vehicle may analyze the captured image or video data to identify objects in the image or video data. The methods and apparatuses may be configured to monitor image and/or video data for the presence of objects of the surrounding environment. In other embodiments, the environment data may be radar, audio, or other data. The vehicle may be configured to identify objects of the surrounding environment based on the radar, audio, or other data.

In some embodiments, the techniques the vehicle uses to detect objects may be based on a set of known data. For example, data related to environmental objects may be stored to a memory located in the vehicle. The vehicle may compare received data to the stored data to determine objects. In other embodiments, the vehicle may be configured to determine objects based on the context of the data. For example, street signs related to construction may generally have an orange color. Accordingly, the vehicle may be configured to detect objects that are orange, and located near the side of roadways as construction-related street signs. Additionally, when the processing system of the vehicle detects objects in the captured data, it also may calculate a confidence for each object.

Further, the vehicle may also have a confidence threshold. The confidence threshold may vary depending on the type of object being detected. For example, the confidence threshold may be lower for an object that may require a quick responsive action from the vehicle, such as brake lights on another vehicle. However, in other embodiments, the confidence threshold may be the same for all detected objects. When the confidence associated with a detected object is greater than the confidence threshold, the vehicle may assume the object was correctly recognized and responsively adjust the control of the vehicle based on that assumption.

When the confidence associated with a detected object is less than the confidence threshold, the actions that the vehicle takes may vary. In some embodiments, the vehicle may react as if the detected object is present despite the low confidence level. In other embodiments, the vehicle may react as if the detected object is not present.

When the vehicle detects an object of the surrounding environment, it may also calculate a confidence associated with the specific detected object. The confidence may be calculated in various ways depending on the embodiment. In one example, when detecting objects of the surrounding environment, the vehicle may compare environment data to predetermined data relating to known objects. The closer the match between the environment data and the predetermined data, the higher the confidence. In other embodiments, the vehicle may use mathematical analysis of the environment data to determine the confidence associated with the objects.

In response to determining that an object has a detection confidence that is below the threshold, the vehicle may transmit, to the remote computing system, a request for remote assistance with the identification of the object. As discussed above, the remote computing system may take various forms. For example, the remote computing system may be a computing device within the vehicle that is separate from the vehicle, but with which a human operator can interact while a passenger or driver of the vehicle, such as a touchscreen interface for displaying remote assistance information. Additionally or alternatively, as another example, the remote computing system may be a remote computer terminal or other device that is located at a location that is not near the vehicle.

The request for remote assistance may include the environment data that includes the object, such as image data, audio data, etc. The vehicle may transmit the environment data to the remote computing system over a network (e.g., network 304), and in some embodiments, via a server (e.g., server computing system 306). The human operator of the remote computing system may in turn use the environment data as a basis for responding to the request.

In some embodiments, when the object is detected as having a confidence below the confidence threshold, the object may be given a preliminary identification, and the vehicle may be configured to adjust the operation of the vehicle in response to the preliminary identification. Such an adjustment of operation may take the form of stopping the vehicle, switching the vehicle to a human-controlled mode, changing a velocity of the vehicle (e.g., a speed and/or direction), among other possible adjustments.

In other embodiments, even if the vehicle detects an object having a confidence that meets or exceeds the threshold, the vehicle may operate in accordance with the detected object (e.g., come to a stop if the object is identified with high confidence as a stop sign), but may be configured to request remote assistance at the same time as (or at a later time from) when the vehicle operates in accordance with the detected object.

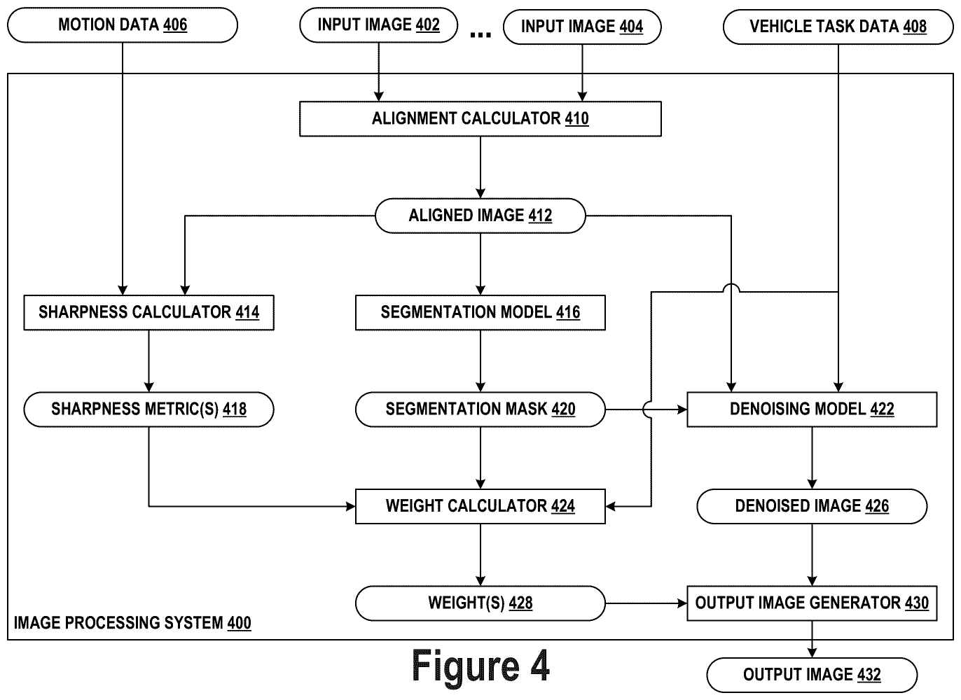

FIG. 4 illustrates an example image processing system 400. Image processing system 400 may be configured to generate output image 432 based on input image 402 through input image 404 (i.e., input images 402-404), motion data 406, and/or vehicle task data 408. Image processing system 400 may be configured to generate output image 432 by sharpening, denoising, and/or otherwise enhancing the visual content of input images 402-404, and may thus provide an improved (e.g., more accurate and/or more memory-efficient) representation of a scene depicted by input images 402-404. Image processing system 400 may include alignment calculator 410, sharpness calculator 414, segmentation model 416, denoising model 422, weight calculator 424, and output image generator 430. Image system 400 and the components thereof may be implemented using hardware, software, or a combination thereof.

Each of input images 402-404 may include a corresponding representation of a scene, and the corresponding representations may differ from one another due to input images 402-404 being captured at different times and/or from different perspectives. Input images 402-404 may be captured sequentially as part of an image capture burst. Input images 402-404 may be collectively referred to as a “burst.” Thus, input images 402-404 may be captured relatively close in time, and the differences in perspectives of the corresponding representations of the scene may be relatively small. Input images 402-404 may be captured by a camera disposed on a vehicle (e.g., an autonomous vehicle, semi-autonomous vehicle, or robotic device), and may thus include blurring and/or other artifacts caused by motion of the vehicle. Although the examples discussed herein are provided in the context of a vehicle, the techniques discussed herein may be applied to any image captured by any camera.

Output image 432 may represent one or more portions of the scene with increased sharpness, thus increasing the amount of detail discernable in output image 432 relative to one or more of input images 402-404. Output image 432 may also represent one or more portions of the scene with reduced noise, thus reducing an amount of data and/or memory resources that output image 432 uses to represent the second or more portions relative to one or more of input images 402-404.

Alignment calculator 410 may be configured to determine, for each respective input image of input images 402-404, a corresponding aligned image based on input images 402-404. Alignment calculator 410 may be configured to select one of input images 402-404 (e.g., a most-recently captured input image) as a base frame relative to which other input images are aligned. For example, alignment calculator 410 may be configured to determine aligned image 412 corresponding to input image 402 by aligning input image 402 with the base frame (e.g., most-recently captured input image 404). The base frame may inherently be aligned with itself.

The corresponding aligned image of the respective input image may represent a translated, rotated, scaled, and/or warped version of the respective input image, such that corresponding visual contents of the respective input image are spatially aligned with the base frame. Thus, representations of the corresponding visual contents may be spatially aligned across the aligned versions of input images 402-404. For example, each respective pixel of a plurality of pixels of aligned image 412 may represent the same feature of the scene as a corresponding pixel (i.e., a pixel with the same coordinates as the respective pixel) of input image 404 selected as the base frame.

Sharpness calculator 414 may be configured to determine, for each respective input image of input images 402-404, corresponding sharpness metric(s) based on the aligned version of the respective input image and, in some implementations, motion data 406. For example, sharpness calculator 414 may be configured to determine sharpness metric(s) 418 based on and corresponding to aligned image 412. Sharpness metric(s) 418 may include one or more values that quantify a sharpness with which aligned image 412 (and thus corresponding input image 402) represents the scene. Sharpness metric(s) 418 may include a frame sharpness value that represents the sharpness of aligned image 412 as a whole, one or more region sharpness values that represent the sharpness of corresponding regions (e.g., semantically-distinct regions, each formed by a corresponding plurality of pixels) of aligned image 412, and/or one or more pixel sharpness values that represent the sharpness of corresponding pixels of aligned image 412. Accordingly, each of the sharpness metric discussed below may be determined at the frame level, region level, and/or the pixel level.

In some implementations, sharpness calculator 414 may be configured to determine sharpness metric(s) 418 based on a subset of motion data 406 that corresponds to input image 402. Motion data 406 may represent a displacement, speed, velocity, and/or acceleration of the camera that captured input images 402-404, the vehicle on which the camera is disposed, and/or one or more features of the scene. Motion data 406 may include samples corresponding to points in time that are associated with input images 402-404. That is, each of input images 402-404 may be associated with one or more motion data samples of motion data 406.

Motion data 406 may include inertial data generated by an inertial measurement unit associated with the camera and/or the vehicle, and/or ground speed data generated by a speedometer of the vehicle. Additionally or alternatively, motion data 406 may include and/or be based on sensor data generated by one or more other sensors provided on the vehicle. For example, motion data 406 may include and/or be based on lidar data generated by one or more lidar devices on the vehicle, and/or radar data generated by one or more radar devices on the vehicle. When the field of view of the lidar device and/or the radar device overlaps with a field of view of the camera, the lidar and/or radar device may be used to measure motion properties (e.g., displacement, speed, velocity, and/or acceleration) of different features in the scene represented by input images 402-404 relative to the camera and/or vehicle.

Thus, for example, motion data 406 may indicate that another vehicle is moving relative to the camera at a first speed (and is thus likely to be blurred by a first amount), while a pedestrian is moving relative to the camera at a second speed different from the first speed (and is thus likely to be blurred by a second amount different from the first amount). Accordingly, motion data 406 may indicate, for each respective pixel of a plurality of pixels of each of input images 402-404, corresponding motion properties associated with the respective pixel, where the corresponding motion properties may be measured by one or more sensors other than the camera, and the motion properties may differ among pixels of a given input image.

Blurring of input images 402-404 may be caused by motion of the camera and/or vehicle relative to different parts of the scene. Thus, motion data 406 may provide information about the amount of blurring likely to be present in input images 402-404 due to movement of the camera, the vehicle, and/or features of the scene. Sharpness calculator 414 may be configured to determine, based on motion data 406, one or more motion properties of the camera relative to the environment when input image 402 has been captured, and determine a motion-based sharpness metric based on the one or more motion properties.

For example, sharpness calculator 414 may implement the function S_{MOTION}=ƒ_{MOTION}(m), where S_{MOTION} represents the motion-based sharpness metric of a respective input image, m represents the one or more motion properties associated with the respective input image (e.g., the velocity and/or acceleration of the camera, vehicle, and/or scene features when capturing the respective input image,), and ƒ_{MOTION}( ) represents a function that maps the one or more motion properties m to the motion-based sharpness metric S_{MOTION}. Since higher speeds and/or accelerations cause motion blur (e.g., when input images 402-404 are captured using relatively long exposure times), the speed-based sharpness metric S_{SPEED} may be inversely proportional to the velocity and/or acceleration of the camera and/or vehicle. For example, S_{MOTION}∝1/m, so that high amounts of motion may tend to lower the motion-based sharpness metric while low amounts of motion may tend to increase the motion-based sharpness metric.

In some implementations, sharpness calculator 414 may be configured to determine sharpness metric(s) 418 by determining one or more gradient values representing one or more gradients of aligned image 412. For example, for each respective pixel of a plurality of pixels of input image 402, sharpness calculator 414 may be configured to determine one or more difference values representing a difference between a value of the respective pixel and one or more neighboring pixels. The gradient value of the respective pixel may be based on, for example, a maximum and/or average of the one or more difference values. A higher gradient value may represent a more abrupt change in pixel values, and may thus indicate a sharper image feature.

For example, sharpness calculator 414 may implement the function S_{GRADIENT}=ƒ_{GRADIENT}(∇pᵢⱼ), where S_{GRADIENT} represents the gradient-based sharpness metric of a respective input image, region thereof, and/or pixel thereof, ∇ represents the gradient operator, pᵢⱼ represents a pixel with horizontal axis index i and vertical axis index j, indexes i and j may be iterated across a plurality of pixels of the respective input image and/or regions thereof, and ƒ_{GRADIENT}( ) represents a function that maps the gradient value(s) of pixel pᵢⱼ to the gradient-based sharpness metric S_{MOTION}.

In some implementations, sharpness calculator 414 may be configured to determine sharpness metric(s) 418 by processing aligned image 412 using a machine learning model. The machine learning model may have been trained (e.g., using gradient descent) to generate a corresponding ML-based sharpness metric for aligned image 412, each of one or more regions thereof, and/or each of one or more pixels thereof. For example, sharpness calculator 414 may implement the function S_{ML}=ƒ_{ML}(I), where S_{ML} represents the ML-based sharpness metric of a respective input image, region thereof, and/or pixel thereof, I represents a respective aligned image, and ƒ_{ML}( ) represents a function implemented by the machine learning model.

A machine learning model may be trained as part of a training phase and, once trained, may be used as part of an inference phase. During the training phase, a machine learning model may be trained using training data to recognize patterns in the training data and output inferences and/or predictions about patterns in the training data. For example, the training data may include a plurality of training images each of which is associated with a corresponding ground truth sharpness metric. During the inference phase, a trained machine learning model can receive input data and responsively provide as an output one or more inferences and/or predictions.

The machine learning model may include an artificial neural network (e.g., a convolutional neural network, a recurrent neural network), a Bayesian network, a hidden Markov model, a Markov decision process, a logistic regression function, a support vector machine, and/or a statistical machine learning algorithm. The machine learning models and/or algorithms used in connection therewith may be supervised or unsupervised. In some examples, the machine learning models can be accelerated using on-device coprocessors, such as graphic processing units (GPUs), tensor processing units (TPUs), digital signal processors (DSPs), and/or application specific integrated circuits (ASICs).

In some implementations, sharpness calculator 414 may be configured to determine sharpness metric(s) 418 based on an exposure time used in connection with capturing input image 402. For example, sharpness calculator 414 may be configured to determine an exposure-based sharpness metric for input image 402 that is inversely proportional to the exposure time, since longer exposure times allow motion of the camera and/or vehicle to introduce more blur into input image 402. In some cases, input images 402-404 may be captured using differing exposure times to provide exposure-based variations in representations of the scene. For example, sharpness calculator 414 may implement the function S_{EXPOSURE}=ƒ_{EXPOSURE}(t_{EXPOSURE}), where S_{EXPOSURE} represents the exposure-based sharpness metric of a respective input image, t_{EXPOSURE} represents the exposure time of the respective input image, and ƒ_{EXPOSURE}( ) represents a function that maps the exposure time to the exposure-based sharpness metric S_{EXPOSURE}.

In some implementations, sharpness calculator 414 may be configured to determine sharpness metric(s) 418 by determining an optical flow of one or more pixels of input image 402 between input image 402 and at least one other image of input images 402-404 (e.g., an input image that is consecutive with input image 402, or the base frame). For example, sharpness calculator 414 may be configured to determine a flow-based sharpness metric for input image 402 that is inversely proportional to the optical flow, since larger displacements correspond to more motion that introduces blur into input image 402. For example, sharpness calculator 414 may implement the function S_{FLOW}=ƒ_{FLOW}(Δpᵢⱼ), where S_{FLOW} represents the flow-based sharpness metric of a respective input image, region thereof, and/or pixel thereof, Δpᵢⱼ represents the pixel flow value(s) associated with a pixel with horizontal axis index i and vertical axis index j, indexes i and j may be iterated across a plurality of pixels of the respective input image and/or regions thereof, and ƒ_{FLOW}( ) represents a function that maps the optical flow value(s) of pixel pᵢⱼ to the flow-based sharpness metric S_{FLOW}.

In other implementations, sharpness calculator 414 may be configured to determine sharpness metric(s) 418 based on additional sharpness measures, including spatial domain sharpness measures, frequency domain sharpness measures, learning based sharpness measures, and/or other techniques for quantifying the sharpness of an image, regions thereof, and/or pixels thereof. Such other sharpness metrics may be represented as S_{OTHER}.

Sharpness calculator 414 may be configured to determine sharpness metric(s) 418 by combining the motion-based sharpness metric, the gradient-based sharpness metric, the ML-based sharpness metric, the exposure-based sharpness metric, the flow-based sharpness metric, and/or the other sharpness metrics into a corresponding total sharpness metric for aligned image 412, each of the different regions thereof, and/or each of the pixels thereof. For example, sharpness calculator 414 may implement the function S_{TOTAL}=ƒ_{TOTAL}(S_{MOTION}+S_{GRADIENT}+S_{ML}+S_{EXPOSURE}+S_{FLOW}+S_{OTHER}), where ƒ_{TOTAL}( ) may provide a normalization that scales the sum of the different sharpness metrics to a predetermined range (e.g., S_{TOTAL} may have a range of zero to one, with zero representing low sharpness and one representing high sharpness). S_{TOTAL} may represent the sharpness metric of input image 402, a region thereof, and/or a pixel thereof.

Segmentation model 416 may be configured to generate segmentation mask 420 corresponding to and/or based on at least one input image of input images 402-404. For example, segmentation model 416 may be configured to generate segmentation mask 420 based on aligned image 412. Segmentation model 416 may include one or more machine learning models (e.g., artificial neural networks) that have been trained to perform image segmentation.

Since the aligned versions of input images 402-404 are related to the base frame and to one another by corresponding transformations determined while aligning input images 402-404, a corresponding segmentation mask may be determined for each of input images 402-404 by transforming segmentation mask 420 using the corresponding transformation. Alternatively or additionally, segmentation model 416 may be configured to generate, for each respective input image of input images 402-404, a corresponding segmentation mask based on processing the respective input image or the aligned version thereof by segmentation model 416.

Segmentation model 416 may be configured to identify the spatial positioning within aligned image 412 of a plurality of visual feature classes present in the scene. The plurality of visual feature classes may include roads, sidewalks, pedestrians, animals, traffic signs, vehicles, traffic cones, sky regions, buildings, and/or any other objects and/or visual features that may be encountered by a vehicle while operating in an environment. Thus, segmentation mask 420 may partition the representation of the scene into a plurality of semantically-distinct regions. In some implementations, the plurality of visual feature classes may depend on a task for which input images 402-404 are captured (e.g., vehicle navigation vs. sensor calibration).

Segmentation mask 420 may include, for each respective pixel of aligned image 412, at least one corresponding segmentation value representing a visual feature class represented by the respective pixel. For example, segmentation mask 420 may include, for each respective pixel of aligned image 412, a plurality of corresponding segmentation values corresponding to the plurality of visual feature classes. Each respective segmentation value of the plurality of corresponding segmentation values may indicate a likelihood that the respective pixel represents a visual feature that belongs to the corresponding visual feature class. In some cases, a highest segmentation value of the plurality of corresponding segmentation values may be selected, and the pixel may be classified as representing the visual feature class associated with the highest segmentation value, thus reducing segmentation mask 420 to one segmentation value per pixel.

Vehicle task data 408 may represent a task to be performed by the vehicle based on input images 402-404. In one example, vehicle task data 408 may assign, to each respective visual feature class of the plurality of visual feature classes, a corresponding importance value (e.g., numerical and/or categorical) that indicates an importance of the respective visual feature class to the task. Different tasks may be associated with different sets of importance values for the plurality of visual feature classes. For example, visual feature classes that are relatively more important to a given task may be assigned higher importance values than visual features that are relatively less important to the given task. Thus, vehicle task data 408 may indicate to image processing system 400 how to process input images 402-404 to balance image quality with computational and/or memory resources expanded during image processing.

Denoising model 422 may be configured to determine, for at least one respective input image of input images 402-404, a corresponding denoised image based on the aligned version of the at least one respective input image, the segmentation mask corresponding thereto, and vehicle task data 408. For example, denoising model 422 may be configured to determine denoised image 426 based on aligned image 412, segmentation mask 420, and vehicle task data 408. Denoising model 422 may be configured to denoise some parts of the scene (thereby reducing the amount of memory involved in representing these parts of the scene), while leaving other parts of the scene unmodified (thereby preserving the visual details of these parts of the scene).

Denoised image 426 may correspond to aligned image 412 with at least some regions thereof denoised (e.g., blurred/de-sharpened) to reduce an amount of data used for representing the visual content of these regions. Specifically, denoising model 422 may be configured to select, based on segmentation mask 420 and vehicle task data 408, one or more denoising regions to which denoising may be applied, and/or one or more sharpening regions to which denoising is not to be applied (i.e., the high-frequency content of which is to be preserved). The one or more denoising regions may correspond to visual feature classes represented in segmentation mask 420 that are relatively unimportant to a task being performed by the vehicle based on input images 402-404, while the one or more sharpening regions may correspond to visual feature classes represented in segmentation mask 420 that are relatively important to the task. For example, the amount of denoising applied to a given visual feature class may be inversely proportional to the importance value assigned to the visual feature class by vehicle task data 408.

Weight calculator 424 may be configured to determine, for each respective input image of input images 402-404, corresponding one or more weights based on the corresponding sharpness metric(s) of the respective input image, the corresponding segmentation mask of the respective input image, vehicle task data 408, and/or one or more other properties of the respective input image. For example, weight calculator 424 may be configured to determine weight(s) 428 corresponding to input image 402 based on sharpness metric(s) 418, segmentation mask 420, vehicle task data 408, and/or other properties of aligned image 412. Weight(s) 428 may be proportional to sharpness metric(s) 418, and may thus be selected to combine the visual content of input images 402-404 in a manner that improves the sharpness of at least some portions of the scene. Weight(s) 428 may be normalized to have values within a predetermined range, such as between zero and one, inclusive.

Weight(s) 428 may include a frame weight corresponding to aligned image 412 as a whole, one or more region weights that correspond to different regions (e.g., semantically-distinct regions) of aligned image 412, and/or one or more pixel weights that correspond to different pixels of aligned image 412. The frame weight may be based on the frame sharpness value of sharpness metric(s) 418, the one or more region weights may be based on corresponding region sharpness values of sharpness metric(s) 418, and/or the one or more pixel weights may be based on corresponding pixel sharpness values of sharpness metric(s) 418. The frame weight of input image i may be represented as wᵢ, the region weight of region j in input image i may be represented as wᵢⱼ, and the pixel weight of pixel k in input image i may be represented as wᵢₖ.

Weight calculator 424 may be configured to determine weight(s) 428 additionally or alternatively based on one or more of (i) an alignment value representing how accurately input image 402 is aligned with the base frame (e.g., with input image 404), (ii) an elapsed time between capturing input image 402 and a reference time, and/or (iii) a signal to noise ratio (SNR) of input image 402, aligned image 412, and/or denoised image 426, among other properties of input image 402. The reference time may represent a time at which the base frame has been captured, and/or a time at which a most recent image of input images 402-404 has been captured. For example, weight(s) 428 may be proportional to the sharpness metric, the alignment value, and the SNR, and/or may be inversely proportional to the elapsed time. Specifically, images that are well-aligned with the base frame, have a higher SNR, and/or have been recently captured may provide more accurate visual data to be used in generating output image 432 than images that are poorly aligned, have a lower SNR, and/or represent visual content likely to be stale due to passage of time.

Weight calculator 424 may implement the function w=g_{TOTAL}(g_{SHARPNESS}(S_{TOTAL}), g_{ALIGN}(A), g_{TEMPORAL}(T), g_{SNR}(N), g_{OTHER}(O)), where w represents any one of wᵢ, wᵢⱼ, Or wᵢₖ. S_{TOTAL} represents the sharpness metric of input image 402, and g_{SHARPNESS}( ) represents a function that maps S_{TOTAL} to a sharpness-based weight. A represents the alignment value of input image 402, and g_{ALIGN}( ) represents a function that maps A to an alignment-based weight. T represents the elapsed time associated with input image 402, and g_{TEMPORAL}( ) represents a function that maps T to a delay-based weight. N represents the SNR associated with input image 402, and g_{SNR}( ) represents a function that maps N to a SNR-based weight. O represents other properties associated with input image 402, and g_{OTHER}( ) represents a function that maps O to a sub-weight based on the other properties associated with input image 402. g_{TOTAL}( ) represents a function (e.g., weighted sum, weighted product, etc.) that maps the sharpness-based weight, the alignment-based weight, the delay-based weight, the SNR-based weight, and one or more other sub-weights to a total weight for the frame, region, and/or pixel.

In some implementations, the operations performed by weight calculator 424 may be conditioned on vehicle task data 408 and/or segmentation mask 420. For example, one or more of the functions g_{SHARPNESS}( ), g_{ALIGN}( ), g_{TEMPORAL}( ), g_{SNR}( ), g_{OTHER}( ), and/or g_{TOTAL}( ) may be configured to receive vehicle task data 408 and/or segmentation mask 420 as input, and/or different versions of one or more of these functions may be used depending on the values of vehicle task data 408 and/or segmentation mask 420. For example, for images, regions thereof, and/or pixels representing semantic content that is relatively important to a task being performed by the vehicle, weight calculator 424 may use functions that prioritize generation of a high-quality output image 432 (possibly at the expense of increased usage of computational resources and/or longer processing times). For images, regions thereof, and/or pixels representing semantic content that is relatively unimportant to a task being performed by the vehicle, weight calculator 424 may use functions that prioritize reducing usage of computational resources and/or shorter processing times (possibly at the expense of generation of a high-quality regions in output image 432). For example, for images, regions thereof, and/or pixels representing semantic content that is relatively unimportant to the task being performed by the vehicle, weight calculator 424 may use some, but not all, of the functions g_{SHARPNESS}( ), g_{ALIGN}( ), g_{TEMPORAL}( ), g_{SNR}( ), g_{OTHER}( ).

Output image generator 430 may be configured to generate output image 432 based on the weight(s) corresponding to input images 402-404 (including weight(s) 428 corresponding to input image 402) and the pixel data of input images 402-404. The pixel data of input images 402-404 may be based on the aligned and/or denoised versions of input images 402-404 (e.g., denoised image 426). As vehicle task data 408 changes, the weight(s) determined for and/or denoising applied to input images 402-404 may also change, resulting in output image generator 430 generating a different task-specific version of output image 432.

Output image generator 430 may implement the function

$${y}_{k} = \frac{{\sum }_{{frame}_{i}} {x}_{ik} {w}_{i} {w}_{ij} {w}_{ik}}{{\sum }_{{frame}_{i}} {\sum }_{{pixel}_{k}} {w}_{i} {w}_{ij} {w}_{ik}} ,$$

where yₖ represents the kth pixel of output image 432, xᵢₖ represents the kth pixel of the ith input image, and wᵢⱼ represents the region weight associated with the region that includes the kth pixel. Thus, output image generator 430 may weigh each respective pixel of each respective aligned image of input images 402-404 based on the visual quality of the respective aligned image, the region(s) thereof, and/or the respective pixel (e.g., as expressed by the numerator of the preceding equation), and may scale this weighted pixel value based on a product of the applied weights (e.g., as expressed by the denominator of the preceding equation). Thus, output image generator 430 may be configured to generate output image 432 by combining the visual information of input images 402-404 and normalizing the color and/or intensity of output image 432.

In some implementations, output image generator 430 may be configured to use a kernel in generating output image 432. For example, the kernel may be a sharpening kernel, a reconstruction kernel, and/or another kernel configured to improve a resulting visual quality of output image 432. The kernel may be predetermined (e.g., learned and/or manually-defined). Output image generator 430 may be configured to generate output image 432 by determining an intermediate image by combining the visual content of input images 402-404 according to weight(s) 428, and convolving the intermediate image with the kernel. Alternatively or additionally, aligned and/or denoised versions of input images 402-404 may be convolved with the kernel prior to being combined on the basis of weight(s) 428.

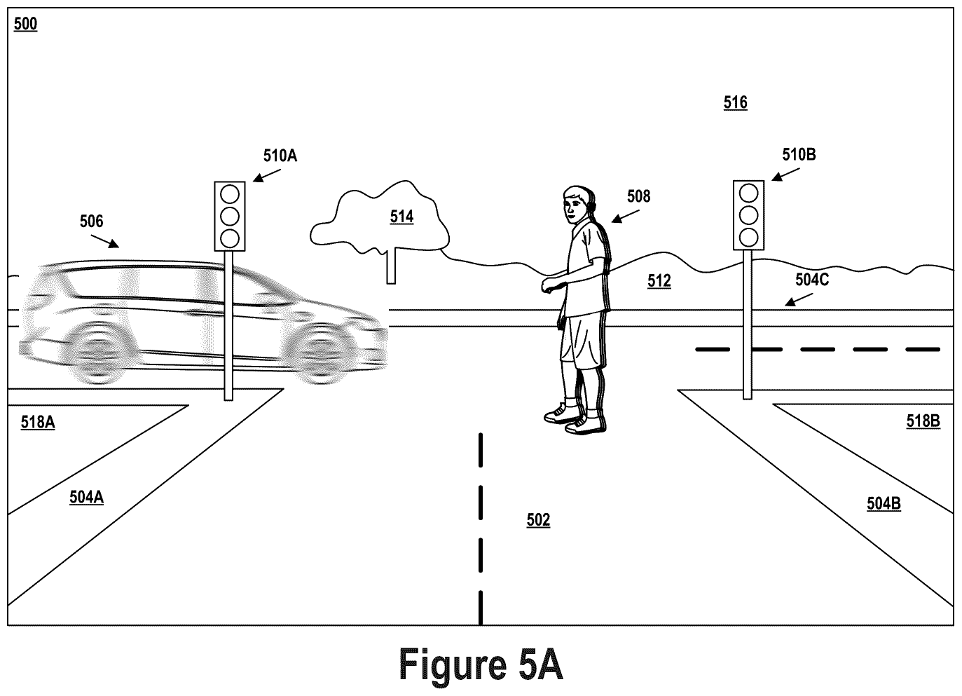

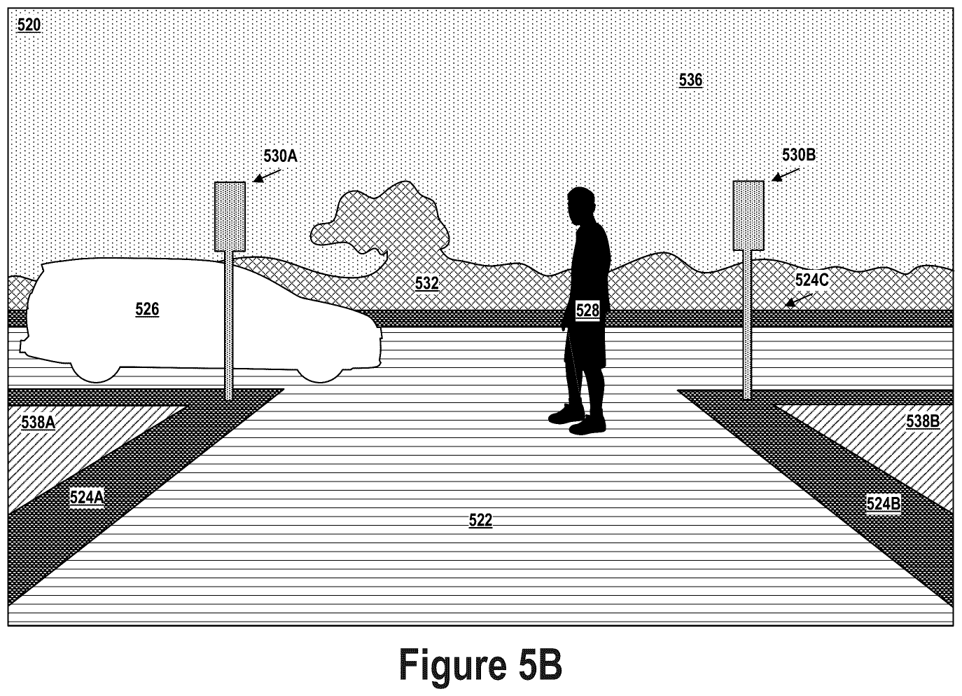

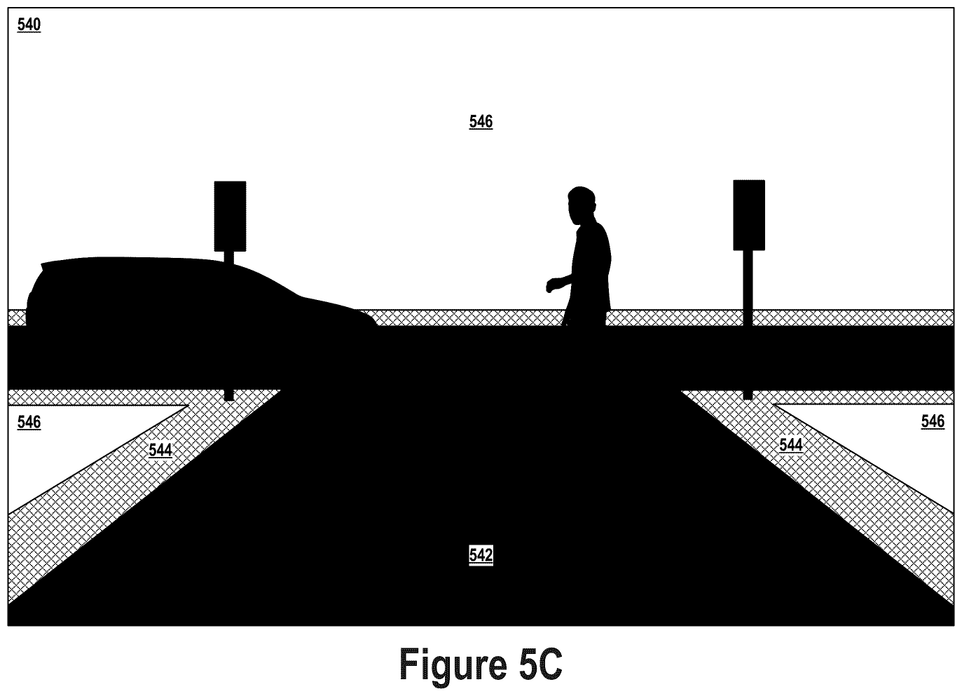

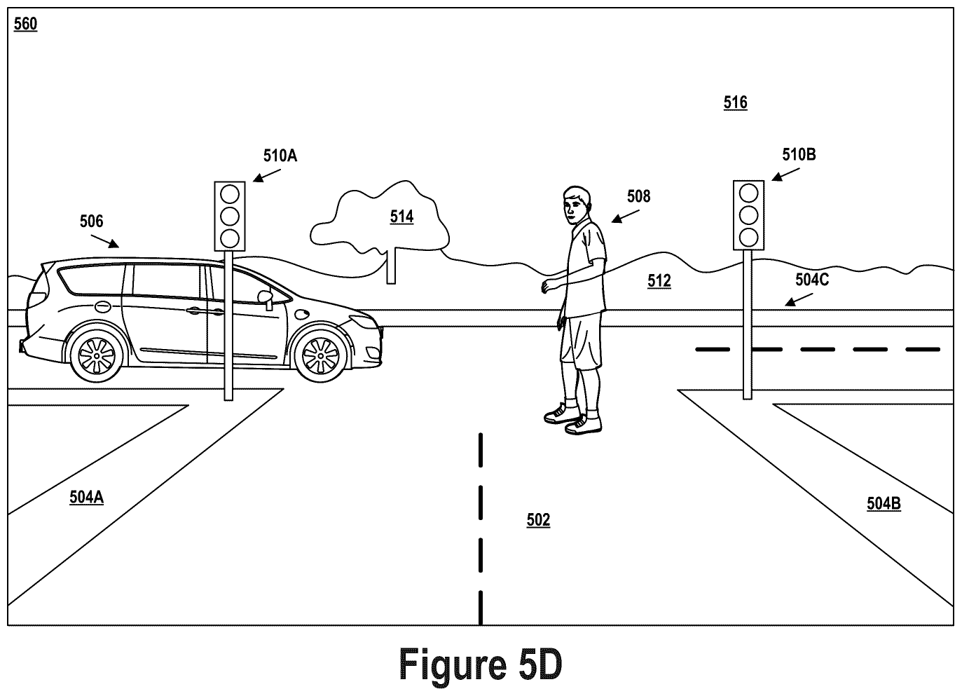

FIG. 5A illustrates an example image 500 that may be processed by image processing system 400 to generate an output image with improved visual characteristics and/or a more memory-efficient scene representation. Image 500 may form part of a plurality of input images captured as part of a burst, with image 500 serving as a representative example of the plurality of images. Image 500 may provide one example of input image 402. Image 500 provides a visual representation of a scene that includes road 502, sidewalks 504A, 504B, and 504C, vehicle 506, pedestrian 508, traffic signals 510A and 510B, landscape 512, tree 514, sky 516, and ground regions 518A and 518B.

In some cases, image 500 may be captured by a camera that is disposed on a vehicle (not shown) operating on road 502. At the time of capture of image 500, the vehicle may be slowing down to a stop, and may thus be moving at a relatively low speed (e.g., under 5 miles per hour) relative to the scene (e.g., in a direction “into” the page of FIG. 5A). Vehicle 506 may be moving from left to right relative to the scene at a relatively high speed (e.g., over 30 miles per hour), and may thus appear highly blurred in image 500. Pedestrian 508 may be moving from right to left at a moderate speed (e.g., above 5 miles per hour but less than 30 miles per hour), and may thus appear moderately blurred in image 500. Other parts of the scene may appear slightly blurred in image 500 due to the relatively low speed of the vehicle that includes the camera.

In order to facilitate performance of various operations based on the representations of the scene in image 500 and the other images that form part of the burst, it may be desirable to generate an output image that includes sharper representations of the scene (e.g., at least vehicle 506 and pedestrian 508). In some implementations, it may be desirable to sharpen the representations of all portions of the scene (i.e., sharpen the entirety of image 500). Such sharpening may be performed by (i) aligning all of the images in the burst relative to a base frame (e.g., a most recently captured image of the burst), (ii) quantifying (e.g., using sharpness calculator 414) the sharpness of all images in the burst, regions thereof, and/or pixels thereof, (iii) determining (e.g., using weight calculator 424) corresponding weights for each of the images in the burst, regions thereof, and/or pixels thereof based on the quantified sharpness and/or other image properties, and (iv) combining the aligned images (e.g., using output image generator 430) in accordance with the corresponding weights.

In other implementations, it may be desirable to sharpen the representations of a first portion of the scene, leave a second portion of the scene unmodified, and/or denoise a third portion of the scene. Such spatially varying modification of representations of the different portions of the scene may be based on a semantic content of the scene and, in some cases, may be conditioned on, and thus vary with, the task being performed by the vehicle.

FIG. 5B illustrates segmentation mask 520 that partitions image 500 into a plurality of semantically-distinct regions. Segmentation mask 520 provides one example of segmentation mask 420. Specifically, road 502 is represented by region 522. Sidewalks 504A, 504B, and 504C are represented by regions 524A, 524B, and 524C, respectively. Vehicle 506 is represented by region 526. Pedestrian 508 is represented by region 528. Traffic signals 510A and 510B are represented by regions 530A and 530B. Landscape 512 and tree 514 are represented by region 532. Sky 516 is represented by region 536. Ground regions 518A and 518B are represented by regions 538A and 538B, respectively. Thus, each respective region of segmentation mask 520 may be associated with a corresponding visual feature class that occupies the respective region.

Each visual feature class may be associated with a corresponding type of image processing operation to be applied thereto, and/or an extent of such processing to be performed. For example, a given visual feature class may be sharpened (e.g., to make it more discernible), left unmodified, or denoised (e.g., to use less data/memory), and the amount of sharpening or denoising applied to different visual features may vary. The type and extent of each image processing operation may be based on an importance of the visual feature class. In some cases, the given visual feature class may be assigned an importance value that remains constant across tasks performed by the vehicle. Thus, the given visual feature may be processed in the same or similar manner regardless of the task assigned to the vehicle. In other cases, the given visual feature class may be assigned an importance value that changes across tasks performed by the vehicle. Thus, the given visual feature may be processed in different ways depending on the task assigned to the vehicle.

FIG. 5C illustrates an importance mask 540 that partitions image 500 into a plurality of regions that, based on the semantic content thereof, vary in importance to the task to be performed by the vehicle based on the image burst. For example, vehicle 506, pedestrian 508, road 502, and traffic signals 510A and 510B may be of high importance (e.g., importance value=1) for a particular task assigned to the vehicle, and the union thereof thus forms high importance region 542. Sidewalks 504A, 504B, and 504C may be of moderate importance (e.g., importance value=0.5) to the particular task, and the union thereof thus forms moderate importance region 544. Landscape 512, tree 514, sky 516, and ground regions 518A and 518B may be of low importance (e.g., importance value=0.01) to the particular task, and the union thereof thus forms low importance region 546. The relative importance of these scene parts is provided as an illustrative example and it is to be understood that the relative importance of different features may be different for different tasks, and the importance value may be quantified using a larger number of numerical and/or categorical values.

Accordingly, image processing system 400 may be configured to apply a high degree of sharpening to high importance region 542, apply a moderate degree of sharpening to moderate importance region 544, and apply denoising (e.g., blurring) to low importance region 546. Applying the high degree of sharpening to high importance region 542 may involve using a first amount of data resources and/or computing resources. For example, high importance region 542 may be sharpened using visual data from all images in the burst, using all of the functions provided by sharpness calculator 414 to calculate corresponding sharpness metrics, using all of the functions provided by weight calculator 424 to calculate corresponding weights, and/or using all computing resources provided by the vehicle and/or camera for the sharpening operation.

Applying the moderate degree of sharpening to moderate importance region 544 may involve using a second amount of data resources and/or computing resources, where the second amount is smaller than the first amount. For example, moderate importance region 544 may be sharpened using visual data from a first image subset (which may be a proper subset) of the images in the burst, using a first sharpness function subset (which may be a proper subset) of the functions provided by sharpness calculator 414 to calculate corresponding sharpness metrics, using a first weight function subset (which may be a proper subset) of the functions provided by weight calculator 424 to calculate corresponding weights, and/or using a first computing resource subset (which may be a proper subset) of the computing resources provided by the vehicle and/or camera for the sharpening operation.

Denoising (e.g., blurring) low importance region 546 may involve using a third amount of data resources and/or computing resources, where the third amount is smaller than the first amount and/or the second amount. For example, low importance region 546 may be denoised using visual data from a second image subset (e.g., that is smaller than the first image subset) of the images in the burst (e.g., using only one image), using a second sharpness function subset (e.g., that is smaller than the first sharpness function subset) of the functions provided by sharpness calculator 414 to calculate corresponding sharpness metrics, using a second weight function subset (e.g., that is smaller than the first weight function subset) of the functions provided by weight calculator 424 to calculate corresponding weights, and/or using a second computing resource subset (e.g., that is smaller than the first computing resource subset) of the computing resources provided by the vehicle and/or camera for the denoising operation.

Accordingly, utilization of data resources and/or computing resources may prioritize more important parts of image 500 while deprioritizing less important parts of image 500. For example, the computing resources saved by deprioritizing the less important parts of image 500 may instead be used to further improve the enhancement process of the more important parts of image 500. In some cases, this may result in a shorter overall image processing time while generating an output image that represents important parts of the scene with improved visual quality.

FIG. 5D illustrates an output image 560 determined based on image 500 and one or more other images of the image burst. Output image 560 may be one example of output image 432. Output image 560 may include a significantly sharpened representation of vehicle 506, pedestrian 508, road 502, and traffic signals 510A and 510B. Output image 560 may also include a moderately sharpened representation of sidewalks 504A, 504B, and 504C. Output image 560 may additionally include a denoised representation of landscape 512, tree 514, sky 516, and ground regions 518A and 518B. Thus, in output image 560, vehicle 506, pedestrian 508, road 502, sidewalks 504A, 504B, and 504C, and traffic signals 510A and 510B may be represented in greater detail than in input image 500, while landscape 512, tree 514, sky 516, and ground regions 518A and 518B may be represented using less data and/or memory resources than in input image 500.

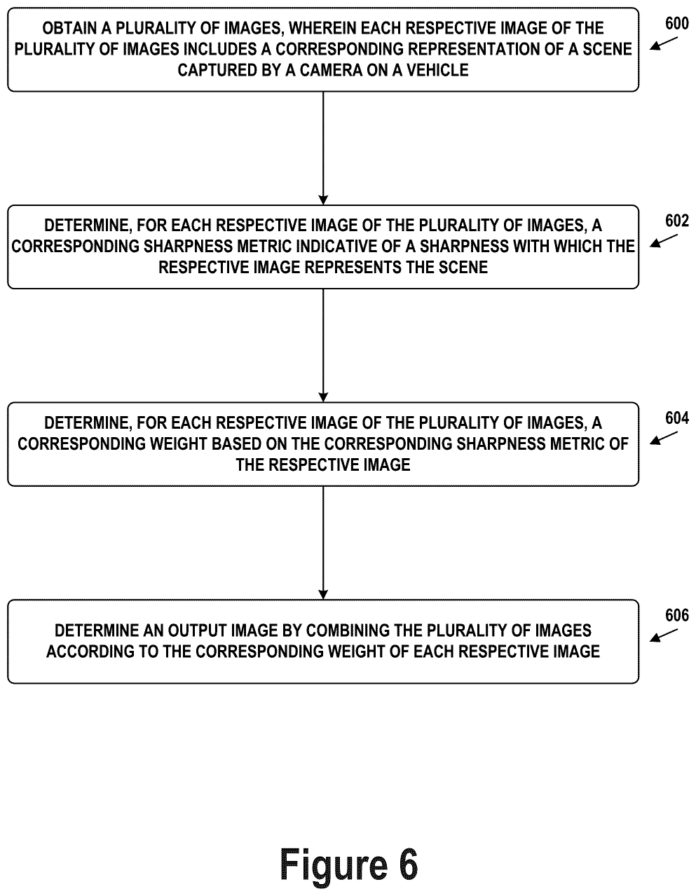

FIG. 6 illustrates a flow chart of operations related to determining a output image that includes an enhanced and/or more efficient representation of a scene represented by a plurality of input images. The operations may be carried out by components of vehicle 100, components of vehicle 200, and/or image processing system 400, among other possibilities. The embodiments of FIG. 6 may be simplified by the removal of any one or more of the features shown therein. Further, these embodiments may be combined with features, aspects, and/or implementations of any of the previous figures or otherwise described herein.

Block 600 may involve obtaining a plurality of images. Each respective image of the plurality of images may include a corresponding representation of a scene captured by a camera on a vehicle.

Block 602 may involve determining, for each respective image of the plurality of images, a corresponding sharpness metric indicative of a sharpness with which the respective image represents the scene.

Block 604 may involve determining, for each respective image of the plurality of images, a corresponding weight based on the corresponding sharpness metric of the respective image.

Block 606 may involve determining an output image by combining the plurality of images according to the corresponding weight of each respective image.

In some examples, the vehicle may be caused to perform one or more operations based on the output image.

In some examples, determining the corresponding sharpness metric may include obtaining corresponding motion data generated by a motion sensors. The corresponding motion data may represent an amount of motion present when the respective image was captured. The corresponding sharpness metric may be determined based on the corresponding motion data.

In some examples, the corresponding sharpness metric may be inversely proportional to the amount of motion present when the respective image was captured. For example, the corresponding sharpness metric of a first image captured when the vehicle is moving at a relatively high speed relative to the environment (thus causing a relatively high amount of motion blur) may be lower than the corresponding sharpness metric of a second image captured when the vehicle is moving at a relatively low speed relative to the environment (thus causing a relatively low amount of motion blur).

In some examples, the corresponding motion data may represent one or more of a displacement, a speed, or an acceleration of the vehicle when the respective image was captured. The motion sensor may include one or more of: (i) an inertial measurement unit, (ii) a speedometer, (iii) a lidar device, or (iv) a radar device.

In some examples, determining the corresponding sharpness metric may include obtaining corresponding inertial data generated by an inertial measurement unit (e.g., associated with the camera). The corresponding inertial data may represent an amount of motion present when the respective image was captured. The corresponding sharpness metric may be determined based on the corresponding inertial data.

In some examples, determining the corresponding sharpness metric may include determining a speed with which the vehicle was moving when the respective image was captured. The corresponding sharpness metric may be determined based on the speed.

In some examples, determining the corresponding sharpness metric may include determining the corresponding sharpness metric based on processing the respective image using a machine learning model.

In some examples, determining the corresponding sharpness metric may include determining a gradient value representing a gradient of the respective image. The corresponding sharpness metric may be determined based on the gradient value. For example, the gradient value may be based on and/or represent a rate of change in pixel values across one or more pixels of the respective image.

In some examples, determining the corresponding sharpness metric may include determining an exposure value representing an exposure time used in connection with generating the respective image. The corresponding sharpness metric may be determined based on the exposure value.

In some examples, determining the corresponding sharpness metric may include determining, for each respective pixel of a plurality of pixels of the respective image, a corresponding optical flow value representing an apparent motion of the respective pixel between the respective image and at least one other image of the plurality of images. The corresponding sharpness metric may be determined based on the corresponding optical flow value of each respective pixel of the plurality of pixels.

In some examples, determining the corresponding sharpness metric may include determining, for each respective pixel of a plurality of pixels of the respective image, a pixel sharpness metric indicative of a sharpness with which the respective pixel represents a corresponding portion of the scene. Determining the corresponding weight may include determining, for each respective pixel of the plurality of pixels of the respective image, a corresponding pixel weight based on the corresponding pixel sharpness metric of the respective pixel. Determining the output image may include combining the plurality of pixels of each respective image according to the corresponding pixel weight of each respective pixel.

In some examples, a segmentation mask representing two or more visual feature classes present in the scene may be determined based on a first image of the plurality of images. Determining the corresponding weight may include determining, for each respective semantically-distinct region of the segmentation mask, a corresponding class weight based on a corresponding visual feature class represented by the respective semantically-distinct region in the first image. For a first one or more visual feature classes, the corresponding class weight may be selected to perform image sharpening and, for a second one or more visual feature classes, the corresponding class weight may be selected to perform image denoising.

In some examples, determining the corresponding weight may include determining, for each respective image of the plurality of images, a corresponding elapsed time between (i) a reference time and (ii) a time at which the respective image has been captured. Determining the corresponding weight may also include determining, for each respective image of the plurality of images, the corresponding weight further based on the corresponding elapsed time.

In some examples, the reference time may represent a time at which a most recent image of the plurality of images has been captured. The corresponding weight may be inversely proportional to the corresponding elapsed time.

In some examples, determining the corresponding weight may include determining, for each respective image of the plurality of images, a corresponding signal-to-noise ratio (SNR), and determining, for each respective image of the plurality of images, the corresponding weight further based on the corresponding SNR.

In some examples, a segmentation mask representing two or more visual feature classes present in the scene may be determined based on a first image of the plurality of images. A first denoised image may be determined by denoising the first image based on the segmentation mask. An extent of denoising applied to each respective pixel of a plurality of pixels of the first image may be based on a visual feature class represented by the respective pixel. The output image may be determined by combining the first denoised image with other images of the plurality of images.

In some examples, determining the first denoised image may include determining, for each respective image of the plurality of images, a corresponding denoised image by denoising the respective image based on the segmentation mask. A corresponding extent of denoising applied to each respective pixel of a plurality of pixels of the respective image may be based on a corresponding visual feature class represented by the respective pixel. The output image may be determined by combining the corresponding denoised image of each respective image of the plurality of images.

In some examples, each respective visual feature class of the two or more visual feature classes may be associated with a corresponding predetermined extent of denoising that allows image portions representing the respective visual feature class to be compressed with at least a threshold compression ratio.

In some examples, determining the output image may include determining an intermediate image by determining a weighted sum of the plurality of images according to the corresponding weight of each respective image, and determining the output image by convolving the intermediate image with a predefined kernel.

In some examples, the plurality of images may be aligned to compensate for variations in different perspectives from which the plurality of images have been captured. The output image may be determined based on the plurality of images as aligned.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a plurality of images, wherein each respective image of the plurality of images includes a corresponding representation of a scene captured by a camera on a vehicle;
determining, for each respective image of the plurality of images, a corresponding sharpness metric indicative of a sharpness with which the respective image represents the scene;
determining, for each respective image of the plurality of images, a corresponding weight based on the corresponding sharpness metric of the respective image; and
determining an output image by combining the plurality of images according to the corresponding weight of each respective image.

2. The method of claim 1, wherein determining the corresponding sharpness metric comprises:
obtaining corresponding motion data generated by a motion sensors, wherein the corresponding motion data represents an amount of motion present when the respective image was captured; and
determining the corresponding sharpness metric based on the corresponding motion data.

3. The method of claim 2, wherein the corresponding sharpness metric is inversely proportional to the amount of motion present when the respective image was captured.

4. The method of claim 2, wherein the corresponding motion data represents one or more of a displacement, a speed, or an acceleration of the vehicle when the respective image was captured, and wherein the motion sensor comprises one or more of: (i) an inertial measurement unit, (ii) a speedometer, (iii) a lidar device, or (iv) a radar device.

5. The method of claim 1, wherein determining the corresponding sharpness metric comprises:
determining the corresponding sharpness metric based on processing the respective image using a machine learning model.

6. The method of claim 1, wherein determining the corresponding sharpness metric comprises:
determining a gradient value representing a gradient of the respective image; and
determining the corresponding sharpness metric based on the gradient value.

7. The method of claim 1, wherein determining the corresponding sharpness metric comprises:
determining an exposure value representing an exposure time used in connection with generating the respective image; and
determining the corresponding sharpness metric based on the exposure value.

8. The method of claim 1, wherein determining the corresponding sharpness metric comprises:
determining, for each respective pixel of a plurality of pixels of the respective image, a corresponding optical flow value representing an apparent motion of the respective pixel between the respective image and at least one other image of the plurality of images; and
determining the corresponding sharpness metric based on the corresponding optical flow value of each respective pixel of the plurality of pixels.

9. The method of claim 1, wherein:
determining the corresponding sharpness metric comprises determining, for each respective pixel of a plurality of pixels of the respective image, a pixel sharpness metric indicative of a sharpness with which the respective pixel represents a corresponding portion of the scene,
determining the corresponding weight comprises determining, for each respective pixel of the plurality of pixels of the respective image, a corresponding pixel weight based on the corresponding pixel sharpness metric of the respective pixel, and
determining the output image comprises combining the plurality of pixels of each respective image according to the corresponding pixel weight of each respective pixel.

10. The method of claim 1, further comprising:
determining, based on a first image of the plurality of images, a segmentation mask representing two or more visual feature classes present in the scene, wherein determining the corresponding weight comprises:
determining, for each respective semantically-distinct region of the segmentation mask, a corresponding class weight based on a corresponding visual feature class represented by the respective semantically-distinct region in the first image, wherein (i), for a first one or more visual feature classes, the corresponding class weight is selected to perform image sharpening and (ii), for a second one or more visual feature classes, the corresponding class weight is selected to perform image denoising.

11. The method of claim 1, wherein determining the corresponding weight comprises:
determining, for each respective image of the plurality of images, a corresponding elapsed time between (i) a reference time and (ii) a time at which the respective image has been captured; and
determining, for each respective image of the plurality of images, the corresponding weight further based on the corresponding elapsed time.

12. The method of claim 11, wherein the reference time represents a time at which a most recent image of the plurality of images has been captured, and wherein the corresponding weight is inversely proportional to the corresponding elapsed time.

13. The method of claim 1, wherein determining the corresponding weight comprises:
determining, for each respective image of the plurality of images, a corresponding signal-to-noise ratio (SNR); and
further determining, for each respective image of the plurality of images, the corresponding weight based on the corresponding SNR.

14. The method of claim 1, further comprising:
determining, based on a first image of the plurality of images, a segmentation mask representing two or more visual feature classes present in the scene; and
determining a first denoised image by denoising the first image based on the segmentation mask, wherein an extent of denoising applied to each respective pixel of a plurality of pixels of the first image is based on a visual feature class represented by the respective pixel, and wherein the output image is determined by combining the first denoised image with other images of the plurality of images.

15. The method of claim 14, wherein determining the first denoised image comprises:
determining, for each respective image of the plurality of images, a corresponding denoised image by denoising the respective image based on the segmentation mask, wherein a corresponding extent of denoising applied to each respective pixel of a plurality of pixels of the respective image is based on a corresponding visual feature class represented by the respective pixel, and wherein the output image is determined by combining the corresponding denoised image of each respective image of the plurality of images.

16. The method of claim 14, wherein each respective visual feature class of the two or more visual feature classes is associated with a corresponding predetermined extent of denoising that allows image portions representing the respective visual feature class to be compressed with at least a threshold compression ratio.

17. The method of claim 1, wherein determining the output image comprises:
determining an intermediate image by determining a weighted sum of the plurality of images according to the corresponding weight of each respective image; and
determining the output image by convolving the intermediate image with a predefined kernel.

18. The method of claim 1, further comprising:
aligning the plurality of images to compensate for variations in different perspectives from which the plurality of images have been captured, wherein the output image is determined based on the plurality of images as aligned.

19. A system comprising:
a processor; and
a non-transitory computer-readable medium having stored thereon instructions that, when executed by the processor, cause the processor to perform operations comprising:
obtaining a plurality of images, wherein each respective image of the plurality of images includes a corresponding representation of a scene captured by a camera on a vehicle;
determining, for each respective image of the plurality of images, a corresponding sharpness metric indicative of a sharpness with which the respective image represents the scene;
determining, for each respective image of the plurality of images, a corresponding weight based on the corresponding sharpness metric of the respective image; and
determining an output image by combining the plurality of images according to the corresponding weight of each respective image.

20. A non-transitory computer-readable medium having stored thereon instructions that, when executed by a computing device, cause the computing device to perform operations comprising:
obtaining a plurality of images, wherein each respective image of the plurality of images includes a corresponding representation of a scene captured by a camera on a vehicle;
determining, for each respective image of the plurality of images, a corresponding sharpness metric indicative of a sharpness with which the respective image represents the scene;
determining, for each respective image of the plurality of images, a corresponding weight based on the corresponding sharpness metric of the respective image; and
determining an output image by combining the plurality of images according to the corresponding weight of each respective image.
